(19) United States
(12) Patent Application Publication
(10) Pub. No.: US 2025/0214339 A1
(43) Pub. Date: Jul. 3, 2025

(54) MEMBER FOR INKJET HEAD, METHOD FOR MANUFACTURING MEMBER FOR INKJET HEAD, AND INKJET HEAD

(71) Applicant: KONICA MINOLTA, INC., Chiyoda-ku, Tokyo (JP)

(72) Inventors: Akihisa YAMADA, Hino-shi, Tokyo (JP); Yusaku TANAKA, Mitaka-shi, Tokyo (JP); Hironori TAKAHASHI, Hino-shi, Tokyo (JP); Akihisa SHIMOMURA, Atsugi-shi, Kanagawa (JP)

(73) Assignee: KONICA MINOLTA, INC., Chiyoda-ku, Tokyo (JP)

(21) Appl. No.: 18/843,721

(22) PCT Filed: Mar. 10, 2023
(86) PCT No.: PCT/JP2023/009193

§ 371 Date: Sep. 4, 2024

(30) Foreign Application Priority Data
Mar. 17, 2022 (JP) 2022-042757

(51) Int. Cl. B41J 2/14; B41J 2/16

(52) U.S. Cl. CPC B41J 2/1433; B41J 2/1628; B41J 2/1634; B41J 2/1646

(57) ABSTRACT

A member for an inkjet head includes at least a base material, a base material adhesion layer and a functional layer in this order. The base material adhesion layer contains a Group 4 or Group 5 element, a nitrogen element and an oxygen element. An atomic concentration (atm %) of the oxygen element on a surface of the base material adhesion layer on a functional layer side where the functional layer is provided is higher than an atomic concentration (atm %) thereof inside the base material adhesion layer.

### TECHNICAL FIELD

The present invention relates to a member for an inkjet head, a method for manufacturing a member for an inkjet head, and an inkjet head. In particular, the present invention relates to a member for an inkjet head which can achieve both durability in a manufacturing process and adhesiveness between a base material and a functional layer, and as a result, can secure long-term durability and rubbing durability with respect to ink, and has an excellent continuous ejection property and so forth.

### BACKGROUND ART

In an inkjet recording apparatus that is currently in widespread use, an inkjet head including a nozzle plate in which a plurality of nozzle holes is formed in a row is attached to and held by a frame or the like, and an image is formed on a recording medium by ejecting each color ink in the form of minute droplets from each of the plurality of nozzles to the recording medium.

Representative ink ejection methods of an inkjet head include a method of ejecting ink by applying pressure to the ink by vaporizing and expanding water in the ink by heat generated by passing a current through an electric resistor disposed in a pressurizing chamber, and a method of ejecting liquid from a nozzle by deforming a pressurizing chamber based on dynamic pressure of each piezoelectric material by forming a part of a channel member constituting a pressurizing chamber as a piezoelectric material or installing a piezoelectric material in a channel member and selectively driving a piezoelectric material corresponding to a plurality of nozzle holes.

In an inkjet head, in order to realize satisfactory ejection performance of ink droplets, surface characteristics of the surface provided with nozzles are very important.

If ink liquid or dust adheres to the vicinity of a nozzle hole of an inkjet head, a problem arises that the ejection direction of ink droplets to be ejected is bent or the ejection angle of ink droplets at the nozzle hole is widened, thereby causing satellites.

In order to stably eject ink droplets, it is needless to say to optimize the design of the inside of an ink channel and a method of applying pressure to ink, but it is insufficient by itself, and it is further necessary to always maintain the periphery of a nozzle hole that ejects ink in a stable surface state. For that purpose, a method of providing a liquid repellent layer having liquid repellency so that unnecessary ink does not adhere to or remain on a peripheral part of a nozzle hole on an ink ejection surface of a nozzle plate has been examined.

In general, a silicone-based compound or a fluorine-containing organic compound, for example, a silane coupling agent, is used for a liquid repellent layer formed on a nozzle surface of a nozzle plate included in an inkjet head. It is known that a liquid repellent layer having excellent adhesion can be formed by using a silane coupling agent for formation of the liquid repellent layer.

Further, it is known that rubbing resistance and chemical resistance can be improved by forming a base material adhesion layer containing TaSiOx on the base material of the nozzle plate before forming the liquid repellent layer (e.g., see Parent Literature 1).

However, there is a problem that such a material is easily peeled off at an interface in the vicinity of the nozzle due to heat of a manufacturing process such as at the time of nozzle processing after the base material adhesion layer and the liquid repellent layer are formed or at the time of plasma treatment used for improving adhesion of the liquid repellent layer.

On the other hand, in Patent Literature 2, there is disclosed a metal nitride film used for a underlayer serving as a base of a liquid repellent layer of a nozzle plate, and in Patent Document 3, there is disclosed a metal nitride film used for an intermediate layer for enhancing a bonding force between a nozzle plate and a bonding film containing organosiloxane, whereby the adhesion of the liquid repellent layer or the bonding film can be improved. However, it is known that in the case of the metal nitride film containing no oxygen atom, the adhesion to the liquid repellent layer or the bonding film cannot be secured.

Further, it is known that, in addition to the liquid repellent layer and the underlayer, a protective layer for protecting the base material from corrosion or an adhesion layer for bonding the base material to another base material is provided on the base material such as the nozzle plate. Further, it is required to improve adhesion between the functional layers such as the liquid repellent layer, the underlayer, the protective layer, and the adhesion layer and the base material.

Further, when a pigment ink is used, a phenomenon has been confirmed in which the surface of the liquid repellent layer gradually wears due to rubbing between a wiping material used at the time of maintenance and the pigment ink containing pigment particles, and by repetition of such an operation over a long period of time, it has been found that there is a problem that durability (rubbing durability) cannot be secured by the above-described layer configuration.

### CITATION LIST

### Patent Literature

[Patent Literature 1] Japanese Patent No. 6217170
[Patent Literature 2] European Patent Application Publication No. 2484526
[Patent Literature 3] Japanese Patent No. 4900457

### SUMMARY OF INVENTION

### Technical Problem

The present invention has been made in view of the above-described problems and circumstances, and an object of the present invention is to provide a member for an inkjet head, a method for manufacturing a member for an inkjet head, and an inkjet head, which can achieve both durability in a manufacturing process and adhesion between a base material and a functional layer, and as a result, can secure long-term durability and rubbing durability with respect to ink, and has an excellent continuous ejection property.

### Solution to Problem

In order to solve the above-described problems, in the process of studying the causes and the like of the above-described problems, the present inventors have found that both durability in a manufacturing process and adhesion between a base material and a functional layer can be achieved, long-term durability and rubbing durability with respect to ink can be secured, and an excellent continuous ejection property can be obtained by making a base material adhesion layer between the base material and the functional layer contain a Group 4 or Group 5 element, a nitrogen element and an oxygen element and making the atomic concentration (atm %) of the oxygen element on the surface of the base material adhesion layer on the functional layer side be higher than that inside the base material adhesion layer, thereby reaching the present invention.

That is, the above-described problems for the present invention are solved by the following means.

1. A member for an inkjet head including at least a base material, a base material adhesion layer and a functional layer in this order,
wherein the base material adhesion layer contains a Group 4 or Group 5 element, a nitrogen element and an oxygen element, and
wherein an atomic concentration (atm %) of the oxygen element on a surface of the base material adhesion layer on a functional layer side where the functional layer is provided is higher than an atomic concentration (atm %) thereof inside the base material adhesion layer.

2. The member for an inkjet head according to item 1, wherein the Group 5 element contained in the base material adhesion layer is tantalum (Ta).

3. The member for an inkjet head according to item 1 or 2, wherein a value of a ratio of an atomic concentration (atm %) of the nitrogen element and an atomic concentration (atm %) of the Group 4 or Group 5 element inside the base material adhesion layer satisfies Formula (I) below:

$$0.3 \leq Atomic Concentration of Nitrogen Element / Atomic Concentration of Group 4 or Group 5 Element \leq 1. \qquad Formula ( I )$$

4. The member for an inkjet head according to any one of items 1 to 3, wherein the base material adhesion layer has a peak derived from Ta₂N in X-ray diffraction (XRD) measurement.

5. The member for an inkjet head according to any one of items 1 to 4, wherein the base material adhesion layer has a thickness within a range of 1 to 1,500 nm.

6. The member for an inkjet head according to any one of items 1 to 5, wherein the functional layer includes a liquid repellent layer containing a fluorine (F) containing-coupling agent.

7. The member for an inkjet head according to any one of items 1 to 6, wherein the functional layer includes a liquid repellent layer containing a fluorine (F) containing-coupling agent, and an underlayer serving as a base of the liquid repellent layer.

8. The member for an inkjet head according to item 7, wherein the underlayer is a layer containing at least an inorganic oxide or an oxide containing carbon (C).

9. The member for an inkjet head according to item 8, wherein the underlayer contains an oxide made of at least carbon (C), silicon (Si) and oxygen (O).

10. The member for an inkjet head according to item 8 or 9, wherein the underlayer is a layer made of a silane coupling agent containing at least carbon (C) and oxygen (O).

11. The member for an inkjet head according to item 10, wherein the silane coupling agent contained in the underlayer has a molecular structure having reactive functional groups at both ends and including a hydrocarbon chain and a benzene ring at a middle portion.

12. The member for an inkjet head according to any one of items 1 to 11, wherein the base material is formed of stainless steel.

13. A method for manufacturing a member for an inkjet head for manufacturing the member for an inkjet head according to any one of items 1 to 12, including:
forming the base material adhesion layer on the base material; and
after forming the functional layer on the base material adhesion layer, forming a nozzle by laser processing.

14. The method for manufacturing a member for an inkjet head according to item 13, wherein the base material adhesion layer is formed by a reactive sputtering method with a dry process.

15. The method for manufacturing a member for an inkjet head according to item 13 or 14, wherein an oxygen plasma treatment is performed as a surface treatment on the base material adhesion layer.

16. An inkjet head including the member for an inkjet head according to any one of items 1 to 12.

### Advantageous Effects of Invention

By the above-described means of the present invention, it is possible to achieve both durability in a manufacturing process and adhesion between a base material and a functional layer, and as a result, it is possible to provide a member for an inkjet head, a method for manufacturing a member for an inkjet head, and an inkjet head which can secure long-term durability and rubbing durability with respect to ink and are excellent in continuous ejection property.

The expression mechanism or action mechanism of the effects of the present invention is not clear, but it is presumed as follows.

In the present invention, since the base material adhesion layer contains a Group 4 or Group 5 element, a nitrogen element, and an oxygen element, heat resistance is enhanced and adhesion can be improved by using a nitride film of a Group 4 or Group 5 element having a high melting point. As a result, it is possible to improve heat resistance in the manufacturing process of a member for an inkjet head and adhesion durability of the interface between the base material and the functional film.

Further, by making the atomic concentration (atm %) of the oxygen element on the surface of the base material adhesion layer on the functional layer side be higher than that inside the base material adhesion layer, a chemical bond such as a covalent bond or a hydrogen bond showing a larger bonding energy easily occurs, and adhesion between the base material and the functional film can be improved. In particular, even when printing is performed over a long period of time with actual ink (sublimation/dispersion dye ink) or the like, permeation of the ink into the interface between the base material and the functional film can be prevented, and long-term durability and rubbing durability can be secured.

Further, the base material adhesion layer containing a Group 4 or Group 5 element, thereby imparting conductivity, can prevent mist adhesion at the time of ink ejection and improve the continuous ejection property.

### BRIEF DESCRIPTION OF DRAWINGS

FIG. 1 This is a schematic sectional view illustrating an example of a nozzle plate.

FIG. 2 This is a schematic sectional view illustrating another example of the configuration of the nozzle plate.

FIG. 3 This is a schematic sectional view illustrating an example of the configuration of a part where a nozzle hole is formed in the nozzle plate.

FIG. 4 This is a graph illustrating an example of concentration distribution curves (depth profiles) of elements in the thickness direction of a base material and a base material adhesion layer.

FIG. 5 This is a graph illustrating an example of a result of XRD diffraction measurement of the base material adhesion layer.

FIG. 6 This is a schematic diagram illustrating an example of a high-frequency plasma apparatus in an RIE mode used for forming the base material adhesion layer.

FIG. 7 This is a schematic perspective view illustrating an example of the structure of an inkjet head to which the nozzle plate of the present invention can be applied.

FIG. 8 This is a bottom view illustrating an example of the nozzle plate constituting the inkjet head shown in FIG. 7.

### DESCRIPTION OF EMBODIMENTS

A member for an inkjet head of the present invention includes at least a base material, a base material adhesion layer and a functional layer in this order, wherein the base material adhesion layer contains a Group 4 or Group 5 element, a nitrogen element and an oxygen element, and wherein an atomic concentration (atm %) of the oxygen element on a surface of the base material adhesion layer on a functional layer side where the functional layer is provided is higher than an atomic concentration (atm %) thereof inside the base material adhesion layer. This feature is a technical feature common to or corresponding to each of the following embodiments.

As an embodiment of the present invention, it is preferable that the Group 5 element contained in the base material adhesion layer is tantalum (Ta) from the viewpoint that conductivity can be imparted and ink ejection properties can be improved.

Further, it is preferable that a value of a ratio of an atomic concentration (atm %) of the nitrogen element and an atomic concentration (atm %) of the Group 4 or Group 5 element inside the base material adhesion layer satisfies Formula (I) (0.3≤Atomic Concentration of Nitrogen Element/Atomic Concentration of Group 4 or Group 5 Element≤1) from the viewpoint of imparting conductivity and preventing mist adhesion at the time of ink ejection.

Further, it is preferable that the base material adhesion layer has a peak derived from Ta₂N in X-ray diffraction (XRD) measurement from the viewpoint of imparting conductivity and preventing mist adhesion at the time of ink ejection.

It is preferable that the base material adhesion layer has a thickness within a range of 1 to 1,500 nm from the viewpoint of nozzle processing and uniformization of nozzle shapes by base material adhesion layer formation distribution.

It is preferable that the functional layer includes a liquid repellent layer containing a fluorine (F) containing-coupling agent in terms of improvement of adhesion to the base material adhesion layer and rubbing durability against ink.

It is preferable that the functional layer includes a liquid repellent layer containing a fluorine (F) containing-coupling agent, and an underlayer serving as a base of the liquid repellent layer from the viewpoint of improvement of adhesion of the liquid repellent layer.

It is preferable that the underlayer is a layer containing at least an inorganic oxide or an oxide containing carbon (C), and further preferable that the underlayer contains, as the oxide containing carbon (C), an oxide made of at least carbon (C), silicon (Si) and oxygen (O), from the viewpoint of being effective in retaining the fluorine (F)-containing coupling agent contained in the liquid repellent layer as the upper layer, and improving the adhesion between the liquid repellent layer and the base material adhesion layer.

Further, it is preferable that the underlayer is a layer made of a silane coupling agent containing at least carbon (C) and oxygen (O), and further the silane coupling agent contained in the underlayer has a molecular structure having reactive functional groups at both ends and including a hydrocarbon chain and a benzene ring at a middle portion from the viewpoints that polymerization to a high density and generation of stacking interaction with each other can improve adhesion between the base material and a constituent layer provided thereon when the base material receives stress in the thickness direction in particular, and also, in a case where the base material is a nozzle plate, can improve resistance when the surface receives stress in the width direction due to a wiping material or the like used at the time of maintenance.

It is preferable that the base material is formed of stainless steel from the viewpoint that more excellent durability can be exhibited.

A method for manufacturing a member of the present invention includes: forming the base material adhesion layer on the base material; and after forming the functional layer on the base material adhesion layer, forming a nozzle by laser processing. By using the base material adhesion layer of the present invention, even when laser processing is performed after formation of the base material adhesion layer and the functional layer, the member for an inkjet head can be produced without causing problems such as thermal deterioration of the base material adhesion and film peeling.

In view of productivity and safety, it is preferable that the base material adhesion layer is formed by a reactive sputtering method with a dry process.

Further, it is preferable that an oxygen plasma treatment is performed as a surface treatment on the base material adhesion layer from the viewpoint that the atomic concentration of the oxygen element on the surface of the base material adhesion layer on the functional layer side can be easily increased.

The member for an inkjet head of the present invention is suitably used for an inkjet head.

Hereinafter, the present invention, constituent elements thereof, and embodiments/modes for carrying out the present invention will be described. In the present application, “- (to)” are used to indicate that numerical values before and the “-” are included as the lower limit value and the upper limit value.

### [Member for Inkjet Head]

A member for an inkjet head of the present invention is a member for an inkjet head including at least a base material, a base material adhesion layer and a functional layer in this order, wherein the base material adhesion layer contains a Group 4 or Group 5 element, a nitrogen element and an oxygen element, and wherein an atomic concentration (atm %) of the oxygen element on a surface of the base material adhesion layer on a functional layer side where the functional layer is provided is higher than an atomic concentration (atm %) thereof inside the base material adhesion layer.

The member for an inkjet head of the present invention is a member constituting an inkjet head, and examples thereof include a member constituting a nozzle plate, a nozzle substrate, an ink channel, an ink chamber, or an exterior portion.

Hereinafter, a nozzle plate will be described as an example of the member for an inkjet head.

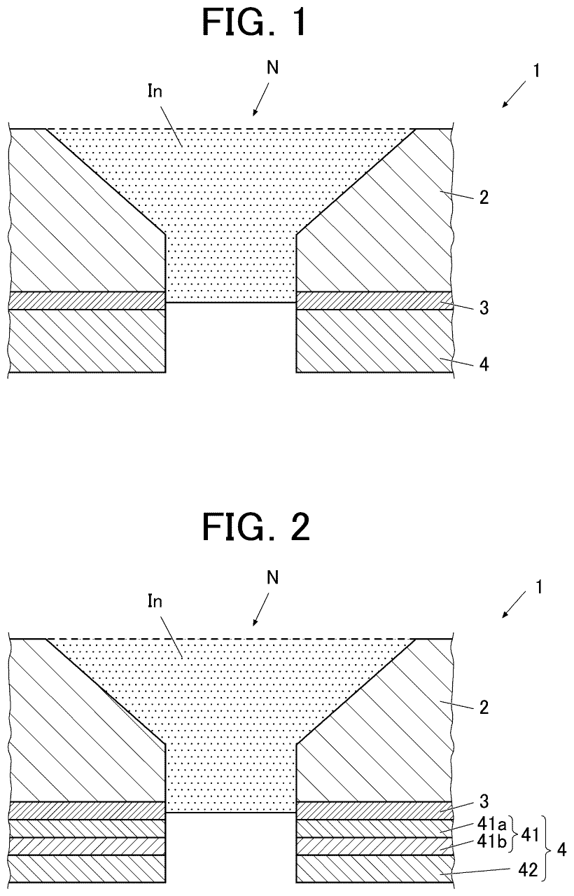

FIG. 1 is a schematic sectional view illustrating an example of a nozzle plate.

As shown in FIG. 1, the basic configuration of a nozzle plate 1 is a configuration in which a base material adhesion layer 3 containing a Group 4 or Group 5 element, a nitrogen element, and an oxygen element is formed on a base material 2, and a functional layer 4 is provided thereon. The atomic concentration (atm %) of the oxygen element on the surface of the base material adhesion layer 3 on the functional layer 4 side is higher than that inside the base material adhesion layer 3.

The functional layer 4 may be, for example, a single liquid repellent layer, a underlayer serving as a base of a liquid repellent layer and the liquid repellent layer, a protective layer for protecting the base material, or an adhesion layer for adhering the base material of the nozzle plate to another base material. Examples of the other base material include base materials of a pressure chamber, a channel substrate, a wiring substrate, a common channel, a cap receiver, and an exterior. Examples of the material include, in addition to stainless steel, metals such as nickel (Ni), gold (Au), aluminum (Al), and copper (Cu), silicon, metal oxides, metal nitrides, resins of polyimide, liquid crystal polymer, PPS, and epoxy, and the like.

FIG. 2 is a schematic sectional view illustrating another example of the configuration of the nozzle plate.

The nozzle plate shown in FIG. 2 has a configuration in which, in contrast to the configuration of the nozzle plate 1 shown in FIG. 1, the functional layer 4 includes an underlayer 41 and a liquid repellent layer 42, and further, the underlayer 41 is an underlayer having a two-layer structure of a first underlayer 41a and a second underlayer 41b.

For example, the first underlayer 41a may contain a silane coupling agent having reactive functional groups at both ends and including a hydrocarbon chain and a benzene ring at the middle portion, and the second underlayer 41b may be composed of oxide containing carbon (C), silicon (Si), and oxygen (O) as main components, for example, a low-molecular-weight silane compound or a silane compound.

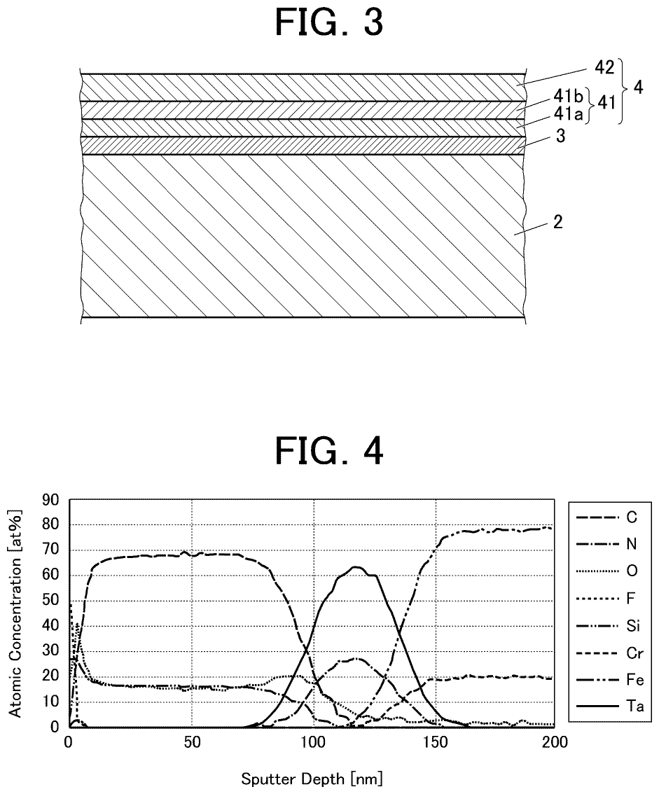

FIG. 3 is a schematic sectional view showing an example of a partial configuration in which a nozzle hole(s) is formed in the above-described nozzle plate.

As shown in FIG. 3, the adhesion between the base material 2 and the functional layer 4 can be improved by providing the base material adhesion layer 3 containing a Group 4 or Group 5 element, a nitrogen element, and an oxygen element between the base material 2 and the functional layer 4 (the underlayer 41 and the liquid repellent layer 42) and making the atomic concentration of the oxygen element on the surface of the base material adhesion layer 3 on the functional layer 4 side higher than that inside.

### [Constituent Materials of Nozzle Plate]

As an example of the nozzle plate according to the present invention, each constituent material of a nozzle plate made of a base material, a base material adhesion layer, an underlayer, and a liquid repellent layer will be described in detail.

In the present invention, the base material adhesion layer contains a Group 4 or Group 5 element, a nitrogen element, and an oxygen element, and the atomic concentration (atm %) of the oxygen element on the surface of the base material adhesion layer on the functional layer side is higher than that inside the base material adhesion layer. In the present invention, the “surface of the base material adhesion layer on the functional layer side” refers to a region within a range of 5 nm depth from the outermost surface on the surface side of the base material adhesion layer in contact with the functional layer. Further, the “inside the base material adhesion layer” refers to a region of the base material adhesion layer except the surface on the functional layer side and the surface on the base material side, that is, a region deeper than a depth of 5 nm from each of the outermost surfaces of the base material adhesion layer on the surface side in contact with the functional layer and the surface side in contact with the base material.

The atomic concentration (atm %) of the oxygen element of the base material adhesion layer on the functional layer side is preferably in a range of 20 to 75 atm %, and more preferably in a range of 25 to 65 atm %. Further, the atomic concentration (atm %) of the oxygen element inside the base material adhesion layer is preferably in a range of 0 to 50 atm % and more preferably in a range of 0 to 35 atm %.

### <Base Material>

The base material constituting the nozzle plate can be selected from materials having high mechanical strength, ink resistance, and excellent dimensional stability, and for example, various materials such as inorganic materials, metal materials, and resin films can be used. Among these, inorganic materials and metal materials are preferable, metal materials such as silicon wafer, iron (for example, stainless steel (SUS)), aluminum, nickel, and stainless steel are more preferable, and stainless steel (SUS) is particularly preferable.

The thickness of the base material constituting the nozzle plate is not particularly limited, and is in a range of 10 to 500 μm, and preferably in a range of 30 to 150 μm.

### <Base Material Adhesion Layer>

The base material adhesion layer according to the present invention contains a Group 4 or Group 5 element, a nitrogen element, and an oxygen element, and the atomic concentration (atm %) of the oxygen element on the surface of the base material adhesion layer on the functional layer side is higher than that inside the base material adhesion layer.

As described above, the surface of the base material adhesion layer on the functional layer side is the surface on the functional layer side in contact with the base material, and generally refers to a region from the outermost surface of the base material adhesion layer to a depth of 5 nm in the base material direction.

Examples of the Group 4 element include titanium (Ti), zirconium (Zr), and hafnium (Hf), and examples of the Group 5 element include vanadium (V), niobium (Nb), and tantalum (Ta), and among these, tantalum (Ta), titanium (Ti), and zirconium (Zr) are preferable, and tantalum (Ta) is particularly preferable.

### (Specific Composition Analysis Method for Base Material Adhesion Layer)

### <Measurement of Composition Ratio of Constituent Elements of Base Material Adhesion Layer>

In the present invention, the method for measuring the composition ratio or the like of the elements constituting the base material adhesion layer is not particularly limited, but, in the present invention, quantification can be performed, for example, by a method of cutting a 10 nm region from the surface of the base material adhesion layer with a glass knife for trimming or the like and quantitatively analyzing the composition of the material constituting the cut portion, a method of quantifying the mass of the compound in the thickness direction of the base material adhesion layer using a method of scanning by infrared spectrometry (IR), atomic absorption or the like, or an XPS (X-ray photoelectron spectroscopy: X-ray Photoelectron Spectroscopy) analysis method if the base material adhesion layer is an extremely thin film of 10 nm or less.

Among these, use of the XPS analysis method is a preferable method from the viewpoint that even an extremely thin film can be subjected to elemental analysis and that the composition distribution profile of the entire base material adhesion layer in the layer thickness direction can be measured by the below-described depth profile measurement.

The X-ray photoelectron spectroscopy is a kind of photoelectron spectroscopy called XPS (X-ray Photoelectron Spectroscopy) or ESCA (Electron Spectroscopy for Chemical Analysis, Esca), and is a method of analyzing constituent elements existing at a surface portion from a sample surface to a depth of 5 nm and an electronic state thereof.

In the base material adhesion layer according to the present invention, as described above, the atomic concentration (atm %) of the oxygen element on the functional layer side is preferably in a range of 20 to 75 atm %, and the atomic concentration (atm %) of the oxygen element inside the base material adhesion layer is preferably in a range of 25 to 65 atm %.

The value of the ratio (S/I) of the atomic concentration (S) of the oxygen element on the surface of the base material adhesion layer on the functional layer side to the atomic concentration (I) of the oxygen element inside the base material adhesion layer is preferably 1.01 or more.

Further, it is preferable that the value of the ratio of the atomic concentrations (atm %) of the nitrogen element and that of the Group 4 or Group 5 element inside the base material adhesion layer satisfies the following formula (I).

$$0.3 \leq Atomic Concentration of Nitrogen Element / Atomic Concentration of Group 4 or Group 5 Element \leq 1. \qquad Formula ( I )$$

The value of the ratio is more preferably within a range of 0.33 to 0.67.

In the present invention, for measurement of the atomic concentrations of the oxygen element on the functional layer side and inside the base material adhesion layer and the atomic concentrations of the nitrogen element and the Group 4 or Group 5 element, it is preferable to use measurement of an atomic concentration distribution in the layer thickness direction.

### <Analysis Method: Measurement of Atomic Concentration Distribution in Layer Thickness Direction>

In the present invention, regarding the atomic concentration distribution curve in the thickness direction of the base material from the base material adhesion layer according to the present invention (hereinafter referred to as “depth profile”), the concentration (atm %) of oxide or nitride of metal, the concentration (atm %) of oxide or nitride of silicon, the concentrations (atm %) of carbon (C), nitrogen (N), oxygen (O), Group 4 or Group 5 element and/or the like can be measured by performing surface composition analysis of the surfaces of the base material adhesion layer from the functional layer side to the base material side successively while exposing the measurement surface, from the surface of the base material adhesion layer on the functional layer side toward the base material side, using both measurement by X-ray photoelectron spectroscopy and ion sputtering with a rare gas or the like.

The distribution curve obtained by this XPS depth profile measurement can be created, for example, with the concentration (unit: atm %) of each element on the vertical axis and the etching time (sputtering time) on the horizontal axis. Note that in the atomic concentration distribution curve in which the horizontal axis represents the etching time, the etching time almost correlates with the distance from the surface of the base material adhesion layer in the layer thickness direction, and therefore as the “distance from the surface of the base material adhesion layer in the thickness direction of the base material adhesion layer”, a distance from the surface of the base material adhesion layer calculated from the relationship between the etching speed and the etching time adopted in the XPS depth profile measurement can be adopted. Further, as a sputtering method employed in the XPS depth profile measurement, a rare gas ion sputtering method using argon (Ar) as an etching ion species can be employed. The etching speed (etching rate) can be measured with a thermal oxide film of SiO₂, the film thickness of which is known in advance, and the etching depth is often expressed by a value in terms of thermal oxide film of SiO₂.

Hereinafter, examples of specific conditions of the XPS analysis applicable to the composition analysis of the base material adhesion layer according to the present invention will be described.
Analyzer: QUANTERA SXM Manufactured by ULVAC-PHI, Inc.
X-ray Source: Monochromatized Al-Kα 15 kV 25 W
Sputter Ion: Ar (1 keV)
Depth Profile: Measurement is repeated at predetermined thickness intervals with the sputter thickness in terms of SiO₂ to obtain the depth profile in the depth direction. This thickness-to-thickness interval is 2.6 nm (data at every 2.6 nm in the depth direction is obtained).
Quantification: The background is obtained by the Shirley method, and quantification is performed from the obtained peak area using the relative sensitivity coefficient method. For data processing, MultiPak manufactured by ULVAC-PHI, Inc. is used.

Hereinafter examples of the measurement results are illustrated.

FIG. 4 shows examples of atomic concentration distribution curves (deth profile) measured by XPS on a nozzle plate composed of a base material (SUS)/base material adhesion layer (TaN)/first underlayer (SiOC)/second underlayer (SiOC)/liquid repellent layer (fluorine containing-coupling agent).

The atomic concentration distribution curves (deth profile) shown in FIG. 4 represent examples in which the base material adhesion layer is formed on the surface of the SUS base material by sputter film formation, and indicate that the oxygen concentration in the surface portion of the base material adhesion layer is higher than the oxygen (O) concentration inside the base material adhesion layer.

A point at which the concentration of carbon (C) derived from the underlayer among the constituent atoms of the base material from the liquid repellent layer is ½ of the peak concentration can be grasped as the base material adhesion layer surface portion (interface between the first underlayer and the base material adhesion layer). That is, the place which is about 94 nm from the surface of the liquid repellent layer with the etching time of 60 (min) can be considered to be the interface between the first underlayer and the base material adhesion layer.

On the other hand, the point at which the oxygen concentration levels off can be grasped as the inside of the base material adhesion layer. That is, here, the place which is about 116 nm from the surface of the liquid repellent layer with the etching time of 74 (min) can be considered to be the interface between the base material adhesion layer and the base material. It is found that there is a layer in which the concentration of oxygen in the surface portion of the base material adhesion layer is higher than the concentration of oxygen inside the base material.

### (X-Ray Diffraction Measurement of Base Material Adhesion Layer)

It is preferable that the base material adhesion layer according to the present invention has a peak derived from Ta₂N in X-ray diffraction (XRD) measurement from the viewpoint of imparting conductivity and preventing mist adhesion at the time of ink ejection.

The X-ray diffraction measurement of the base material adhesion layer can be performed by the following procedure.

A 6-inch silicon wafer is used as a base material, and sputtering film formation is performed on the base material using a Ta target under an atmosphere of argon gas and nitrogen gas to form a base material adhesion layer.

Specifically, under vacuum conditions, a preset Ta target is sputtered on an electrode of a DC sputtering film forming apparatus under the following conditions.
Sputtering Conditions
Target: Ta
DC Power Density: 1.1 W/cm²
Power: 200 W
Temperature: 25° C.
Pressure: 0.3 Pa
Introduced Gas: Argon Gas+Nitrogen Gas
Film Formation Time: 10 min

The base material adhesion layer formed on the silicon wafer described above is measured under the following conditions using an X-ray diffractometer (multipurpose X-ray diffractometer Ultima III manufactured by Rigaku Corporation) to obtain an X-ray diffraction pattern.
Apparatus: Multipurpose X-ray Diffractometer Ultima III manufactured by Rigaku Corporation
X-ray Source: Cu-kα 40 kV-30 mA
Scanning Axis: θ/2θ
Scanning Range: 25° to 85° (Sampling Width: 0.02°)
Scan Speed: 10°/min

FIG. 5 shows an example of the result of XRD diffraction measurement of the base material adhesion layer.

As shown in FIG. 5, in the measured X-ray diffraction spectrum, 2θ has been reverted to, at 32.6°, a peak derived from Ta₂N.

### (Resistivity of Base Material Adhesion Layer)

The resistivity of the base material adhesion layer according to the present invention is preferably a low value within the range of 1×10⁻⁸ to 1×10¹⁶ Ωcm.

For example, the resistivity of TaN contained in the base material adhesion layer according to the present invention shows a low resistivity in the range of 100 to 350 μΩ cm as described in Japanese Unexamined Patent Publication No. S50-35698, while the resistivity of Ta₂O₅ shows a high insulating property and shows a high resistivity. As a method for measuring the resistivity, a two-terminal method, a four-terminal method, a four-probe method and the like are known.

### (Method for Forming Base Material Adhesion Layer)

The method for forming the base material adhesion layer according to the present invention is not particularly limited, but the following methods can be applied.

Examples of the film formation method of the base material adhesion layer which can be applied to the present invention include dry film formation methods such as a physical vapor deposition method (PVD method) and a chemical vapor deposition method (CVD method), wet film formation methods such as electrolytic plating and electroless plating, and the like, and in the present invention, formation by a dry film formation method is preferable in that a thin and dense film can be formed.

In the present invention, examples of the dry film formation method include a sputtering method, a vacuum deposition method, a laser ablation method, an ion plating method, an electron beam epitaxy method (MBE method), a metal organic chemical vapor deposition method (MOCVD method), a plasma CVD method, a plasma etching mode method using an oxygen gas (O₂PE mode), and a reactive ion etching method using an oxygen gas (O₂RIE mode), and from the viewpoint that a thin and dense film having a high metal element concentration can be formed, a sputtering method and a plasma etching mode method using an oxygen gas (O₂PE mode) are preferable.

In the present invention, among the above-described methods, the method of performing the surface treatment by the plasma treatment after the film formation by the sputtering method is preferable in that a desired base material adhesion layer can be formed.

### (Specific Film Formation Method of Base Material Adhesion Layer)

Typical methods for forming the base material adhesion layer include the following methods.

1. Film Formation Method: After a metallic layer made of a Group 4 or Group 5 element (content: 30 to 70 atm %) is formed on a base material by a sputtering method with the Group 4 or Group 5 element as a target, the metallic layer is subjected to plasma treatment described later to form a base material adhesion layer. Note that hereinafter, Ta (tantalum) will be described as an example of the metal made of the Group 4 or Group 5 element.

### (1) Formation of Base Material Adhesion Layer by Sputtering

In the sputtering method, a metal of a Group 4 or Group 5 element (e.g., Ta) is used as a target, and sputtering film formation is performed under an atmosphere of an argon gas, an oxygen gas, a nitrogen gas, methane, or the like, so that a base material adhesion layer is formed.

In order to form a film containing nitrogen (nitride film) on the nozzle plate as in the present invention, a method of performing sputtering film formation under an atmosphere of nitrogen gas using a metal target of a Group 4 or Group 5 element (reactive sputtering) or a method of performing sputtering film formation under an atmosphere of argon gas using a target of a nitride of a metal of a Group 4 or Group 5 element can be used. The former (reactive sputtering) is preferably used because it is easy to perform control to be an optimum film composition.

An example of a specific film formation method using a sputtering method is described below.

Under vacuum conditions, a preset Ta target on an electrode of a DC sputtering film forming apparatus is sputtered under the following conditions. At the time, not DC sputtering but another plasma source may be used.
Target: Ta
DC Power Density: 1.1 W/cm²
Power: 200 W
Temperature: 25° C.
Pressure: 0.3 Pa
Introduced Gas: Argon Gas+Nitrogen Gas
Film Formation Time: 10 min
   (2) Plasma Treatment after Sputtering

Examples of the plasma etching mode applicable to the present invention can include an RIE mode and a PE mode. The “RIE” (Reactive Ion Etching) mode referred to in the present invention is a method in which in an opposing planar electrode pair, a base material constituting a nozzle plate as a plasma treatment object to be subjected to plasma treatment, for example, SUS304, is disposed on the feed electrode side, and plasma treatment is performed on the surface of the plasma treatment object. Meanwhile, the “PE” (Plasma Etching) mode is a method in which, in an opposing planar electrode pair, a plasma treatment object to be subjected to plasma treatment is disposed on the ground electrode side, and plasma treatment is performed on the surface of the plasma treatment object.

Further, details of the plasma etching mode will be described with reference to the drawings.

### <RIE Mode Plasma Treatment Apparatus>

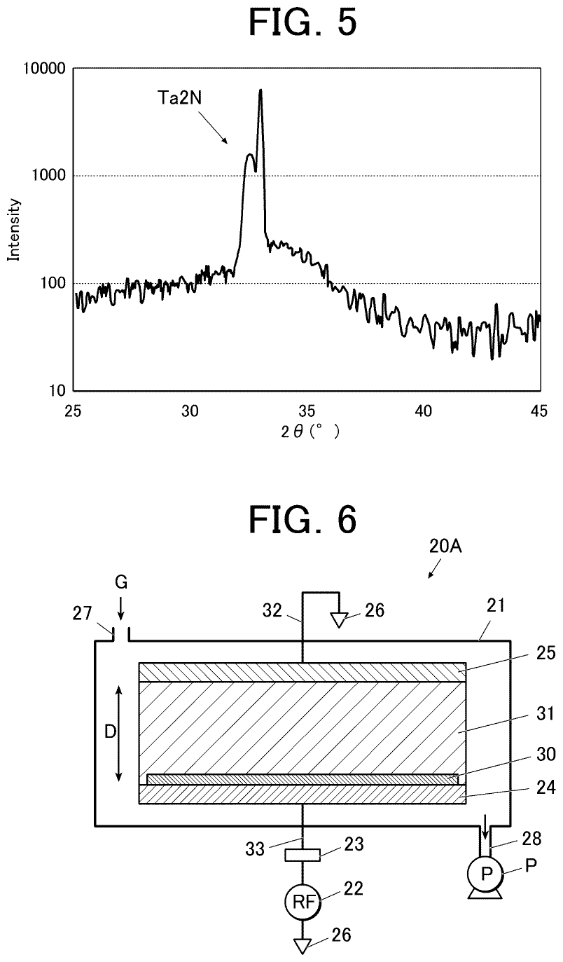

FIG. 6 is a schematic view showing an example of a high-frequency plasma apparatus of an RIE mode (reactive ion etching mode) used for forming the base material adhesion layer. The RIE mode is suitable for physical and high-speed surface treatment by ion bombardment.

In FIG. 6, a high-frequency plasma apparatus 20A of the RIE mode (hereinafter, also referred to as the “plasma treatment apparatus 20A”) includes a reaction chamber 21, a high-frequency power source 22 (RF (Radio Frequency) power source), a capacitor 23, a planar electrode 24 (cathode, also referred to as “feed electrode”), a counter electrode 25 (anode, also referred to as “ground electrode”), a ground portion 26, and the like. The reaction chamber 21 has a gas inlet 27 and a gas outlet 28. The planar electrode 24 and the counter electrode 25 are disposed in the reaction chamber 21.

The pair of electrodes made of the planar electrode 24 connected to the high-frequency power source 22 via the capacitor 23 and the counter electrode 25 facing the planar electrode 24 and grounded by the ground portion 26 is arranged in the sealable reaction chamber 21. Further, a nozzle plate base material 30 as the plasma treatment object is placed on the planar electrode 24.

First, air is sufficiently removed from the reaction chamber 21 via the gas outlet 28.

In this state, when the high-frequency power source 22 is started while a reactant gas G (Ar, O₂, etc.) is supplied into the reaction chamber 21 via the gas inlet 27, and power at a high frequency of 3 MHz or more and 100 MHz or less (usually, 13.56 MHz) is supplied to the high-frequency power source 22, discharge D occurs between the planar electrode 24 and the counter electrode 25 to form a discharge space 31 where low-temperature plasma (cations and electrons) and radical species of the reactant gas G are generated. At the time, the high-frequency power density is preferably set within a range of 0.01 to 3 W/cm.

In the above-described configuration, due to the difference in mobility between ions and electrons, the electrons are collected by the planar electrode 24 to charge the planar electrode 24 relatively negatively (self-bias). The electrons of the planar electrode 24 stop at the capacitor 23 via a feed line 33. Further, the electrons of the counter electrode 25 flow to the ground portion 26 via a feed line 32.

Meanwhile, the radical species and the cations are not easily collected by the electrode and move in the plasma. When the nozzle plate base material 30 as an object to be treated is placed on the planar electrode 24 in this plasma, an ion sheath in which a strong electric field is generated occurs on the counter electrode 25 side of the nozzle plate base material 30, an electric field of 400 to 1000 V is generated due to cathode lowering, and the cations moving in the nozzle plate base material 30 collide with or contact with the surface of the nozzle plate base material 30. Thus, the surface treatment (here, etching) on the object to be treated is performed.

Examples of the reactive gas G used for etching include rare gases (e.g., helium gas, neon gas, argon gas, krypton gas, and xenon gas), oxygen gas, and hydrogen gas. In the present invention, the RIE mode plasma treatment method using argon gas as the reactive gas G is referred to as “Ar-RIE mode plasma treatment”, and the RIE mode plasma treatment method using oxygen gas as the reactive gas is referred to as “O₂-RIE mode plasma treatment”

### (Layer Thickness of Base Material Adhesion Layer)

In the nozzle plate of the present invention, the layer thickness of the base material adhesion layer is in a range of about 1 to 20,000 nm, but is preferably in a range of 1 to 5,000 nm from the viewpoint of nozzle processing and nozzle shape uniformity by base material adhesion layer formation distribution, and is further preferably in a range of 1 to 1,500 nm from the viewpoint of producibility.

### <Underlayer>

The underlayer according to the present invention is a layer formed between the base material adhesion layer and the liquid repellent layer according to the present invention, and it is preferable to contain at least inorganic oxide or oxide containing carbon (C).

The inorganic oxide applicable to the formation of the underlayer according to the present invention is not particularly limited, and examples thereof include oxides and composite oxides of metals such as transition metals, noble metals, alkali metals, and alkaline earth metals. More specifically, the inorganic oxide fine particles are preferably oxide or composite oxide containing one or more kinds of metal element selected from silicon, aluminum, titanium, magnesium, zirconium, antimony, iron, and tungsten.

The oxide or composite oxide may further contain one or more kinds selected from phosphorus, boron, cerium, alkali metal and alkaline earth metal.

Examples of common inorganic oxide include aluminum oxide, silica (silicon dioxide), magnesium oxide, zinc oxide, lead oxide, tin oxide, tantalum oxide, indium oxide, bismuth oxide, yttrium oxide, cobalt oxide, copper oxide, manganese oxide, selenium oxide, iron oxide, zirconium oxide, germanium oxide, tin oxide, titanium oxide, niobium oxide, molybdenum oxide, vanadium oxide and the like.

Further, in the present invention, the underlayer is preferably a layer containing the inorganic oxide composed of silicon dioxide as a main component. The inorganic oxide may contain an organic substance such as an organic group or a resin as an accessory component.

The underlayer is preferably an organic oxide containing at least carbon (C).

Examples of the organic oxide containing carbon (C) include, as silicon compound, silane, tetramethoxysilane, tetraethoxysilane (TEOS), tetra-n-propoxysilane, tetraisopropoxysilane, tetra n-butoxysilane, tetra t-butoxysilane, dimethyldimethoxysilane, dimethyldiethoxysilane, diethyldimethoxysilane, diphenyldimethoxysilane, methyltriethoxysilane, ethyltrimethoxysilane, phenyltriethoxysilane, (3,3,3-trifluoropropyl) trimethoxysilane, hexamethyldisiloxane, bis-(dimethylamino) dimethylsilane, bis-(dimethylamino) methylvinylsilane, bis-(ethylamino) dimethylsilane, N,O-bis-(trimethylsilyl) acetamide, bis-(trimethylsilyl) carbodiimide, diethylaminotrimethylsilane, dimethylaminodimethylsilane, hexamethyldisilazane, hexamethylcyclotrisilazane, heptamethyldisilazane, nonamethyltrisilazane, octamethylcyclotetrasilazane, tetrakisdimethylaminosilane, tetraisocyanatosilane, tetramethyldisilazane and the like, and as titanium compound, titanium methoxide, titanium ethoxide, titanium isopropoxide, titanium tetraisopropoxide, titanium n-butoxide, titanium diisopropoxide (bis-2,4-pentanedionate), titanium diisopropoxide (bis-2,4-ethylacetoacetate), titanium di-n-butoxide (bis-2,4-pentanedionate), titanium acetylacetonate, butyl titanate dimer and the like. Examples as zirconium compound include zirconium n-propoxide; zirconium n-butoxide; zirconium t-butoxide; zirconium tri-n-butoxide acetylacetonate; zirconium di-n-butoxide bis-acetylacetonate; zirconium acetylacetonate; zirconium acetate; zirconium hexafluoropentanedionate; and the like Examples as aluminum compound include aluminum ethoxide; aluminum triisopropoxide; aluminum isopropoxide; aluminum n-butoxide; aluminum s-butoxide; aluminum t-butoxide; aluminum acetylacetonate; triethyldialuminum tri-s-butoxide; and the like.

It is further preferable that, among the organic oxides containing carbon (C), a layer containing carbon (C), silicon (Si), and oxygen (O) as main components is formed using a silane compound (for example, alkoxysilane or silazane) or a silane coupling agent having a molecular weight of 300 or less.

The underlayer according to the present invention is preferably a layer formed using a silane coupling agent, and further, the silane coupling agent contained in the underlayer preferably has reactive functional groups at both ends and includes a hydrocarbon chain and a benzene ring at the middle portion.

As a specific configuration of the underlayer, for example, as the inorganic oxide applicable to the underlayer according to the present invention, for example, it is a preferable aspect (first underlayer) that the underlayer forms a high-density polymerized film by dehydration condensation reaction of a silane coupling agent A having reactive functional groups at both terminals and including a hydrocarbon chain and a benzene ring at a middle portion, and it is another preferable aspect (second underlayer) that the underlayer is composed of inorganic oxide or oxide composed of organic oxide containing at least Si as a main component.

(Formation of Underlayer with Silane Coupling Agent A: First Underlayer)

In the present invention, as the silane coupling agent used for forming the underlayer by a dehydration condensation reaction, it is preferable to apply a silane coupling agent A having reactive functional groups at both terminals and including a hydrocarbon chain and a benzene ring at the middle portion.

The silane coupling agent A applicable to the underlayer is not particularly limited, and a conventionally known compound satisfying the above-described requirements can be appropriately selected and used. However, from the viewpoint of fully exhibiting the intended effect of the present invention, it is preferably a compound represented by the following general formula (I) and having an alkoxy group, chlorine, an acyloxy group, or an amino group as a reactive functional group at both ends and a structure including a hydrocarbon chain and a benzene ring (phenylene group) at the middle portion.

### <Compound Having Structure Represented by General Formula 1>

XsQ₃-sSi(CH₂)tC₆H₄(CH₂)uSiR₃-mXm General Formula (I):

In the general formula (I), Q and R each represent a methyl group or an ethyl group, t and u each represent a natural number of 1 to 10, and s and m each represent a natural number of 1 to 3. When s is 1 and m is 1, two Qs and two Rs are present, and the two Qs and the two Rs may each have the same structure or different structures. C₆H₄ is a phenylene group. X represents an alkoxy group, chlorine, an acyloxy group, or an amino group.

The alkoxy group is, for example, an alkoxy group having 1 to 12 carbon atoms, such as a methoxy group, an ethoxy group, a propoxy group, or a butoxy group, preferably an alkoxy group having 1 to 8 carbon atoms, more preferably an alkoxy group having 1 to 6 carbon atoms, or the like.

Examples of the acyloxy group include a linear or branched acyloxy group having 2 to 19 carbon atoms (acetoxy, ethylcarbonyloxy, propylcarbonyloxy, isopropylcarbonyloxy, butylcarbonyloxy, isobutylcarbonyloxy, sec-butylcarbonyloxy, tert-butylcarbonyloxy, octylcarbonyloxy, tetradecylcarbonyloxy, octadecylcarbonyloxy and the like), and the like.

Examples of the amino group include amino groups (—NH₂) and substituted amino groups having 1 to 15 carbon atoms (e.g., methylamino, dimethylamino, ethylamino, methylethylamino, diethylamino, n-propylamino, methyl-n-propylamino, ethyl-n-propylamino, n-propylamino, isopropylamino, isopropylmethylamino, isopropylethylamino, diisopropylamino, phenylamino, diphenylamino, methylphenylamino, ethylphenylamino, n-propylphenylamino, and isopropylphenylamino, and the like) and the like.

Exemplary compounds having the structure represented by General Formula (I) according to the present invention are listed below, but the present invention is not limited to these exemplary compounds.
1) 1,4-bis(trimethoxysilylethyl) benzene
2) 1,4-bis(triethoxysilylethyl) benzene
3) 1,4-bis(trimethoxysilylbutyl) benzene
4) 1,4-bis(triethoxysilylbutyl) benzene
5) 1,4-bis(trimethylaminosilylethyl) benzene
6) 1,4-bis(triethylaminosilylethyl) benzene
7) 1,4-bis(trimethylaminosilylbutyl) benzene
7) 1,4-bis(triacetoxysilylethyl) benzene
8) 1,4-bis(trichloromethylsilylethyl) benzene
9) 1,4-bis(trichloroethylsilylethyl) benzene

The compound having the structure represented by General Formula (I) according to the present invention can be obtained by synthesis according to a conventionally known synthesis method. It is also available as a commercial product.

### <Method for Forming Underlayer Using Silane Coupling Agent A>

The underlayer according to the present invention is formed by dissolving the silane coupling agent A having reactive functional groups at both ends and including a hydrocarbon chain and a benzene ring at the middle portion according to the present invention in an organic solvent such as ethanol, propanol, butanol, 2,2,2-trifluoroethanol or the like to be a desired concentration to prepare an application liquid for underlayer formation, and then applying the application liquid onto a base material by a wet application method and drying.

The concentration of the silane coupling agent A in the application liquid for underlayer formation is not particularly limited, but is in the range of about 0.5 to 50% by mass and preferably in the range of 1.0 to 30% by mass.

The layer thickness of the first underlayer according to the present invention is not particularly limited, but is preferably in the range of about 1 to 500 nm, and more preferably in the range of 5 to 200 nm.

### (Formation of Underlayer Composed of Oxide Containing Organic Oxide Containing Si as Main Component: Second Underlayer)

It is also preferable that the underlayer according to the present invention is a second underlayer composed of an oxide containing, as a main component, an organic oxide containing Si.

Preferably, as shown in FIG. 2, the underlayer 41 is composed of two layers of a first underlayer 41a and a second underlayer 41b, the first underlayer 41a is composed of the first underlayer containing the silane-coupling agent A having reactive functional groups at both ends and including a hydrocarbon chain and a benzene ring at the middle portion, which is described above, and the second underlayer 41b is composed of the second underlayer composed of an organic oxide containing Si, which is described below.

Examples of the alkoxysilane, the silazane and the silane coupling agent having a molecular weight of 300 or less that can be applied to the present invention are shown, but the present invention is not limited to these exemplified compounds. Note that the numerical value in parentheses after each compound is a molecular weight (Mw).

Examples of the alkoxysilane include tetraethoxysilane (Si(OC₂H₅)₄, Mw: 208.3), methyltriethoxysilane (CH₃Si(OC₂H₅)₃, Mw: 178.3), methyltrimethoxysilane (CH₃Si(OCH₃)₃, Mw: 136.2), dimethyldiethoxysilane ((CH₃)₂Si(OC₂H₅)₂, Mw: 148.3), dimethyldimethoxysilane ((CH₃)₂Si(OCH₃)₂, Mw: 120.2), and the like.

Examples of the silazane include 1,1,1,3,3,3-hexamethyldisilazane ((CH₃)₃SiNHSi(CH₃)₃, 161.4), 1,1,1,3,3,3-hexaethyldisilazane ((C₂H₅)₃SiNHSi(C₂H₅)₃, 245.4), 1,3-bis(chloromethyl) tetramethyldisilazane, 1,3-divinyl-1,1,3,3-tetramethyldisilazane and the like.

As the silane coupling agent, 1) Vinyl-based silane coupling agent: vinyltrimethoxysilane (CH₂=CHSi(OCH₃)₃, Mw: 148.2), vinyltriethoxysilane (CH₂=CHSi(OC₂H₅)₃, Mw: 190.3), CH₂=CHSi(CH₃)(OCH₃)₂, CH₂=CHCOO(CH₂)₂Si(OCH₃)₃, CH₂=CHCOO(CH₂)₂Si(CH₃)Cl₂, CH₂=CHCOO(CH₂)₃SiCl₃, CH₂=C(CH₃)Si (OC₂H₅)₃ and the like can be exemplified.

2) Amino silane coupling agent: 3-aminopropyltrimethoxysilane (H₂NCH₂CH₂CH₂Si(OCH₃)₃, mW: 179.3), 3-(2-aminoethylamino) propyltrimethoxysilane (H₂NCH₂CH₂NHCH₂CH₂CH₂Si(OCH₃)₃, Mw: 222.4), 3-(2-aminoethylamino)propylmethyldimethoxysilane (H₂NCH₂CH₂NHCH₂CH₂CH₂Si(CH₃)(OCH₃)₂, Mw: 206.4) and the like can be exemplified

3) Epoxy-based silane coupling agent: 3-glycidoxypropyltrimethoxysilane (Mw: 236.3), 3-glycidoxypropyltriethoxysilane (Mw: 278.4), and the like can be exemplified.

### <Method for Forming Second Underlayer>

The second underlayer according to the present invention is formed by dissolving the silane compound having a molecular weight of 300 or less according to the present invention, for example, a conventionally known alkoxysilane, silazane or a silane coupling agent, in an organic solvent, for example, ethanol, propanol, butanol, 2,2,2-trifluoroethanol or the like, to a desired concentration to prepare an application liquid for forming an interlayer, and then applying and drying the application liquid on the underlayer by a wet application method.

The concentration of the material for forming an inorganic oxide in the application liquid for forming a second underlayer is not particularly limited, but is in the range of about 0.5 to 50% by mass, and preferably in the range of 1.0 to 30% by mass.

The layer thickness of the second underlayer according to the present invention is in a range of 0.5 to 500 nm, preferably in a range of 1 to 300 nm, and more preferably in a range of 5 to 100 nm.

### <Liquid Repellent Layer>

In the present invention, the liquid repellent layer (also referred to as “water repellent layer”) preferably contains a coupling agent having fluorine (F) (hereinafter, also referred to as coupling agent B).

The coupling agent B having fluorine (F) which can be applied to the liquid repellent layer according to the present invention is not particularly limited, but it is preferable that it contains a fluorine-based compound, and the fluorine-based compound is a compound having a perfluoroalkyl group containing at least an alkoxysilyl group, a phosphonic acid group or a hydroxy group, or a compound having a perfluoropolyether group containing an alkoxysilyl group, a phosphonic acid group or a hydroxy group, or (2) a mixture containing a compound having a perfluoroalkyl group, or a mixture containing a compound having a perfluoropolyether group.

Examples of the specific compound of the coupling agent B having fluoride (F) that can be applied to the liquid repellent layer according to the present invention include chlorodimethyl [3-(2,3,4,5,6-pentafluorophenyl) propyl]silane, pentafluorophenyldimethylchlorosilane, pentafluorophenylethoxydimethylsilane, pentafluorophenylethoxydimethylsilane, trichloro (1H,1H,2H,2H-tridecafluoro-n-octyl) silane, trichloro (1H,1H,2H,2H-heptadecafluorodecyl) silane, trimethoxy (3,3,3-trifluoropropyl) silane, triethoxy (1H,1H,2H,2H-nonafluorohexyl) silane, triethoxy-1H,1H,2H,2H-heptadecafluorodecylsilane, trimethoxy (1H,1H,2H,2H-heptadecafluorodecyl) silane, trimethoxy (1H,1H,2H,2H-heptadecafluorodecyl) silane, trimethoxy (1H,1H,2H,2H-nonafluorohexyl) silane, trichloro [3-(pentafluorophenyl) propyl] silane, trimethoxy (11-pentafluorophenoxyundecyl) silane, triethoxy [5,5,6,6,7,7,7-heptafluoro-4,4-bis(trifluoromethyl) heptyl]silane, trimethoxy (pentafluorophenyl) silane, and triethoxy (1H,1H,2H,2H-nonafluorohexyl) silane.

The silane coupling agent having fluorine (F) is readily available as commercial products sold, for example, from Dow Corning Toray Silicone Co., Ltd., Shin-Etsu Chemical Co., Ltd., Daikin Industries, Ltd. (e.g., OPTOOL DSX), Asahi Glass Co., Ltd. (e.g., Cytop), Seco Corporation (e.g., TopCleanSafe®), FluoroTechnology Co., LTD. (e.g., Fluorosurf), Gelest Inc, and Solvay Solexis, Inc. (e.g., FluorolinkS10). In addition, compounds described in, for example, J. Fluorine Chem., 79 (1). 87 (1996), Material Technology, 16 (5), 209 (1998), Collect. Czech. Chem. Commun., vol. 44, pages 750 to 755, J. Amer. Chem. Soc. 1990, vol. 112, pages 2341 to 2348, Inorg. Chem., vol. 10, pages 889 to 892, 1971, U.S. Pat. No. 3,668,233 and the like can be exemplified. In addition, it can be produced by synthesis methods described in Japanese Unexamined Patent Publication No. S58-122979, Japanese Unexamined Patent Publication No. H7-242675, Japanese Unexamined Patent Publication No. H9-61605, Unexamined Patent Publication No. 11-29585, Japanese Unexamined Patent Publication No. 2000-64348, Unexamined Patent Publication No. 2000-144097 and the like, and synthesis methods analogous thereto.

Specific examples of the compound having a silane group-terminated perfluoropolyether group include “OPTOOL DSX” manufactured by Daikin Industries, Ltd, examples of the compound having a silane group-terminal fluoroalkyl group include “FG-5010Z130-0.2” manufactured by Fluorosurf Corporation, examples of the polymer having a perfluoroalkyl group include “SF-Coat Series” manufactured by AGC Seimi Chemical Co., Ltd, and examples of the polymer having a fluorine-containing heterocyclic structure in the main chain include “Cytop” manufactured by Asahi Glass, Inc. Further, a mixture of an FEP (tetrafluoroethylene-hexafluoropropylene copolymer) dispersion and a polyamide-imide resin can also be exemplified.

Further, as a no-silane-group-terminated coupling agent having fluorine (F), a phosphonic acid derivative (for example, FOPA) having a fluorinated alkyl chain manufactured by Dojindo Laboratories, and the like are also applicable.

As a method for forming the liquid repellent layer by the PVD method, it is preferable to use Evaporation Substances WR1 and WR4 manufactured by Merck & Co., Inc., which are fluoroalkylsilane mixed oxides, as the fluorine-based compound, and, for example, to form a silicon oxide layer in advance as an underlayer as a base for forming the liquid repellent layer by WR1 on the silicon base material. The liquid repellent layer formed of WR1 and WR4 exhibits liquid repellency to, in addition to water, organic solvents such as alcohols such as ethanol, ethylene glycol (including polyethylene glycol), thinners, and paints.

The layer thickness of the liquid repellent layer according to the present invention is in a range of about 1 to 500 nm, preferably in a range of 1 to 400 nm, and more preferably in a range of 2 to 200 nm.

### [Method for Manufacturing Member for Inkjet Head]

In the method for manufacturing the member for an inkjet head of the present invention, the base material adhesion layer is formed on the base material, the functional layer is formed on the base material adhesion layer, and then a nozzle is formed by laser processing.

In particular, the base material adhesion layer is preferably formed by a reactive sputtering method using a dry process, and an oxygen plasma treatment is preferably performed as the surface treatment on the base material adhesion layer.

As an example of the method for manufacturing the member for an inkjet head, a method for manufacturing a nozzle plate having the above-described underlayer and liquid repellent layer as the functional layer will be described below.

The method for manufacturing the nozzle plate includes, as described in detail above,
1) forming a base material adhesion layer on the base material,
2) making the atomic concentration of an oxygen element on the surface of the base material adhesion layer on the functional layer side higher than that inside the base material adhesion layer,
3) subsequently forming an underlayer on the base material adhesion layer with an inorganic oxide or an oxide containing carbon (C);
4) subsequently forming a liquid repellent layer on the underlayer using a coupling agent having fluorine (F); and
5) subsequently forming a nozzle(s) by laser processing in the base material, the base material adhesion layer, the underlayer, and the liquid repellent layer.

FIG. 2 is a schematic sectional view showing an example of the configuration of a nozzle hole portion of the nozzle plate according to the present invention.

As shown in FIG. 2, a nozzle part N having a desired shape is formed as an ink ejection section in the base material 2, the base material adhesion layer 3, the underlayer 41, and the liquid repellent layer 42.

For a specific method for forming the nozzle hole or the like, methods described in Tokuka 005-533662, Japanese Unexamined Patent Publication No. 2007-152871, Japanese Unexamined Patent Publication No. 2007-313701, Japanese Unexamined Patent Publication No. 2009-255341, Japanese Unexamined Patent Publication No. 2009-274415, Japanese Unexamined Patent Publication No. 2009-286036, Japanese Unexamined Patent Publication No. 2010-023446, Japanese Unexamined Patent Publication No. 2011-011425, Japanese Unexamined Patent Publication No. 2013-202886, Japanese Unexamined Patent Publication No. 2014-144485, Japanese Unexamined Patent Publication No. 2018-083316, Japanese Unexamined Patent Publication No. 2018-111208 and the like can be referred to, and detailed description thereof is omitted here.

The nozzle plate manufactured as described above can achieve both the durability in the manufacturing process and the adhesion between the base material and the underlayer and the liquid repellent layer, and can secure the long-term durability against ink and the rubbing durability.

In the nozzle plate of the present invention, a nozzle hole(s) is preferably formed by laser processing.

In the method for manufacturing the nozzle plate according to the present invention, it is preferable to use a laser in the processing of the outer shape of the nozzle hole, and it is more preferable that the laser is a pulse laser or a CW laser.

As the laser applicable in the manufacturing of the nozzle plate according to the present invention, a continuous oscillation type laser beam (CW laser beam) or a pulsed oscillation type laser beam (pulsed laser beam) is preferably used.

Examples of the laser beam that can be used here include those oscillated from one or more kinds of gas lasers such as an Ar laser, a Kr laser, and an excimer laser, a laser with, as a medium, single crystal YAG, YVO₄, forsterite (Mg₂SiO₄), YAlO₃, GdVO₄ or YLF, or polycrystalline (ceramic) YAG, Y₂O₃, YVO₄, YAlO₃ or GdVO₄ to which one or more kinds of Nd, Yb, Cr, Ti, Ho, Er, Tm and Ta are added as a dopant(s), a glass laser, a ruby laser, an alexandrite laser, a Ti:sapphire laser, a copper vapor laser and a gold vapor laser.

Among these, it is preferable that the laser to be used emits ultraviolet laser light having a wavelength of about 266 nm, for example, YAG-UV (yttrium-aluminum-garnet crystal: wave length 266 nm) or YVO₄ (wave length: 355 nm). In particular, a laser having a wavelength of about 266 nm can dissociate molecular bonds such as C—H bonds or C—C bonds by thermal action when the processing object is an organic material.

As an example of the irradiation conditions, for example, for YAG-UV (wavelength: 266 nm), the pulse width is 12 nsec and output is 1.6 W, and for YVO4 (wavelength: 355 nm), the pulse width is 18 nsec and output is 2.4 W.

Further, it is also possible to use an ultrafast laser which generates intense laser pulses with the duration of approximately 10⁻¹¹ seconds (10 psec) to 10⁻¹⁴ seconds (10 fsec) or a short-pulse laser which generates intense laser pulses with the duration of approximately 10⁻¹⁰ seconds (100 psec) to 10⁻¹¹ seconds (10 psec). These pulsed lasers are also useful for cutting or drilling a wide range of materials.

### [Inkjet Head]

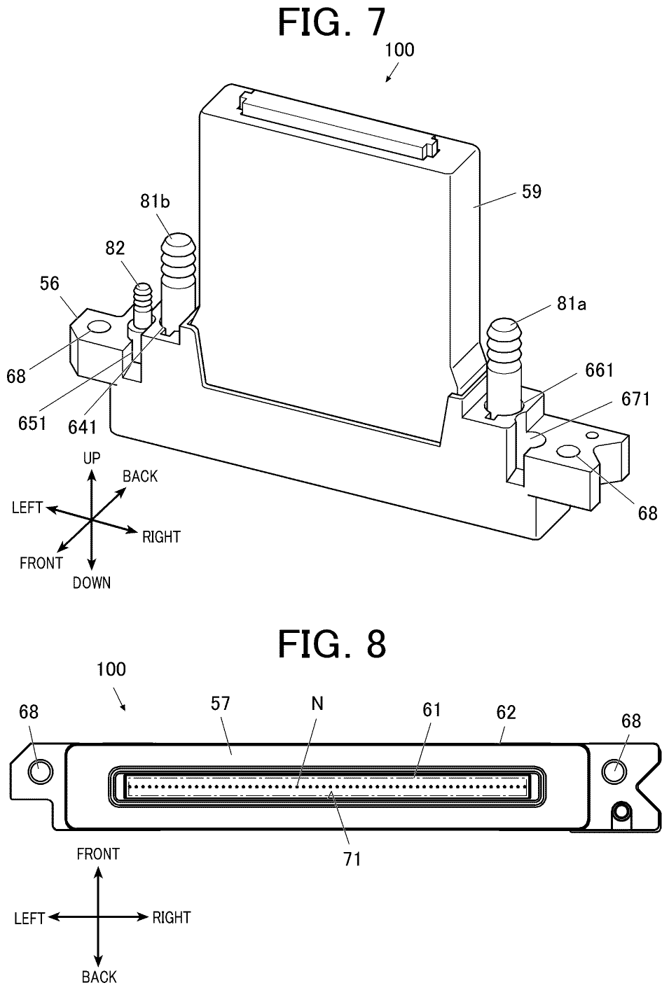

FIG. 7 is a schematic external view showing an example of the structure of an inkjet head to which the nozzle plate according to the present invention can be applied. FIG. 8 is a bottom view of an inkjet head including the nozzle plate according to the present invention.

As shown in FIG. 7, an inkjet head 100 having the nozzle plate according to the present invention is the one that is mounted on an inkjet printer (not shown), and includes a head chip for ejecting ink from a nozzle, a wire base material on which the head chip is disposed, a drive circuit base material connected to the wire base material via a flexible base material, a manifold for introducing ink into a channel of the head chip via a filter, a housing 56 in which the manifold is housed, a cap receiving plate attached to close a bottom opening of the housing 56, first and second joints 81a and 81b attached to first and second ink ports of the manifold, a third joint 82 attached to a third ink port of the manifold, and a cover member 59 attached to the housing 56. Further, attachment holes 68 for attaching the housing 56 to the printer body side are formed.

Further, the cap receiving plate 57 shown in FIG. 8 is formed in a substantially rectangular plate shape whose outer shape is long in the left-right direction to correspond to the shape of a cap receiving plate attachment portion 62, and at substantially the central portion, an opening portion for a nozzle 71 which is long in the left-right direction is provided in order to expose the nozzle plate 61 in which a plurality of nozzles N is disposed. Further, with respect to the specific structure of the inside of the inkjet head shown in FIG. 7, for example, FIG. 2 and the like in Japanese Unexamined Patent Publication No. 2012-140017 can be referred to.

FIGS. 7 and 8 show a typical example of the inkjet head, but, for example, any of an inkjet heads having configurations described in Japanese Unexamined Patent Publication No. 2012-140017, Japanese Unexamined Patent Publication No. 2013-010227, Japanese Unexamined Patent Publication No. 2014-058171, Japanese Unexamined Patent Publication No. 2014-097644, Japanese Unexamined Patent Publication No. 2015-142979, Japanese Unexamined Patent Publication No. 2015-142980, Japanese Unexamined Patent Publication No. 2016-002675, Japanese Unexamined Patent Publication No. 2016-002682, Japanese Unexamined Patent Publication No. 2016-107401, Japanese Unexamined Patent Publication No. 2017-109476, Japanese Unexamined Patent Publication No. 2017-177626 and so forth can be appropriately selected and applied.

### [Inkjet Ink]

The inkjet ink applicable to the inkjet recording method using the inkjet head of the present invention is not particularly limited, and examples thereof include various kinds of inkjet ink such as water-based inkjet ink containing water as a main solvent, oil-based inkjet ink containing a nonvolatile solvent which does not volatilize at room temperature as a main component and containing substantially no water, organic solvent-based inkjet ink containing a solvent which volatilizes at room temperature as a main component and containing substantially no water, hot-melt ink which is solid at room temperature and heated and melted for printing, and active energy ray-curable inkjet ink which is cured by active rays such as ultraviolet rays after printing. However, in the present invention, it is preferable to use alkaline ink from the viewpoint that the effect of the present invention can be exhibited.

As the ink, there are, for example, alkaline ink and acidic ink, and in particular, alkaline ink may cause chemical deterioration of the base material, the liquid repellent layer, and the nozzle formation face, but in an inkjet recording method using such alkaline ink, it is particularly effective to apply the inkjet head including the nozzle plate of the present invention.

Specifically, ink applicable to the present invention includes a color material such as a dye or a pigment, water, a water-soluble organic solvent, a pH adjuster, and so forth. As the water-soluble organic solvent, for example, ethylene glycol, propylene glycol, diethylene glycol, dipropylene glycol, glycerin, triethylene glycol, ethanol, propanol, or the like can be used. As the pH adjuster, for example, sodium hydroxide, potassium hydroxide, sodium acetate, sodium carbonate, sodium bicarbonate, alkanolamine, hydrochloric acid, acetic acid, or the like can be used.

In the case where sodium hydroxide, potassium hydroxide, sodium acetate, sodium carbonate, sodium bicarbonate, alkanolamine, or the like is used as the pH adjuster, the ink exhibits alkalinity, and becomes alkaline ink (liquid) which may cause chemical damage (chemical deterioration) of the liquid repellent layer or the nozzle formation face. The alkaline ink has a pH of 8.0 or more.

As described above, the liquid repellent layer is formed of a fluorine-containing silane coupling agent or the like. The liquid repellent layer has a structure in which a partial structure containing silicon and a partial structure containing fluorine are bonded to each other with a substituent such as a methylene group (CH₂) Since the bond energy between carbon (C) and carbon (C) is smaller than the bond energy between silicon (Si) and oxygen (O) and the bond energy between carbon (C) and fluorine (F), the portion where carbon (C) and carbon (C) are bonded has a weaker bond and is more susceptible to mechanical damage and chemical damage than the portion where silicon (Si) and oxygen (O) are bonded and the portion where carbon (C) and fluorine (F) are bonded.

In the inkjet recording method using an alkaline ink that tends to cause such a phenomenon, it is effective to apply the nozzle plate having the configuration defined in the present invention in terms of enhancing durability.

### EXAMPLES

Hereinafter, the present invention will be specifically described by way of Examples, but the present invention is not limited thereto. Note that in the following Examples, operations were performed at room temperature (25° C.) unless otherwise specified. Further, unless otherwise specified, “%” and “part(s)” mean “% by mass” and “part(s) by mass”, respectively.

### Example 1

### [Production of Nozzle Plate 1]

In accordance with the following method, a nozzle plate 1 composed of base material 2/base material adhesion layer 3/first underlayer 41a/second underlayer 41b/liquid repellent layer 42 shown in FIG. 2 was produced.

### (1) Preparation of Base Material

As a base material, a stainless-steel base material (SUS304) having a size of 3 cm in length×8 cm in width×50 μm in thickness and not subjected to surface treatment was used.

### (2) Formation of TaN Layer (Base Material Adhesion Layer X) by Sputtering Method

As the sputtering method, sputtering film formation was performed on the base material in an atmosphere of argon gas and nitrogen gas using Ta as a target to form a metal nitride film layer.

Specifically, under vacuum conditions, a preset Ta target was sputtered on an electrode of a DC sputtering film forming apparatus under the following conditions.
Target: Ta
DC Power Density: 1.1 W/cm²
Power: 200 W
Temperature: 25° C.
Pressure: 0.3 Pa
Introduced Gas: Argon Gas+Nitrogen Gas
Film Formation Time: 10 min
Layer Thickness: 20 nm

### (3) Formation of First Underlayer

### (Preparation of Application Liquid for Forming First Underlayer)

### <Preparation of Solution A-1>

The following constituent materials were mixed to prepare a solution A-1.

| | |
|---|---|
| Mixed Solution of Ethanol and 2,2,2-trifluoroethanol (8:2 in | 30 mL |
| volume ratio) | |
| Silane Coupling Agent a: 1,4-bis(trimethoxysilylethyl)benzene | 2 mL |
| ((CH₃O)₃Si(CH₂)₂(C₆H₄)(CH₂)₂Si(OCH₃)₃) (see below) | |

### <Preparation of Solution A-2>

| | |
|---|---|
| Mixed Solution of Ethanol and 2,2,2-trifluoroethanol (8:2 in | 19.5 mL |
| volume ratio) | |
| Pure Water | 30 mL |
| Hydrochloric Acid (36 vol %) | 0.5 mL |

### (Formation of First Underlayer)

While the prepared A-1 solution was stirred with a stirring bar, 5 mL of the A-2 solution was dropped. After the dropping, the mixture was stirred for about 1 hour, and then this mixed liquid was applied onto the base material adhesion layer by a spin coating method under the condition that the layer thickness of the first underlayer after drying became 100 nm. The conditions of the spin coating were 5,000 rpm and 20 seconds. Thereafter, the base material was dried at room temperature for 1 hour and then fired at 200° C. for 30 minutes.

### (4) Formation of Second Underlayer

### (Preparation of Application Liquid for Forming Second Underlayer)

The following constituent materials were mixed to prepare an application liquid for forming a second underlayer.

| | |
|---|---|
| Mixed Solution of Ethanol and 2,2,2-trifluoroethanol (8:2 in | 69 mL |
| volume ratio) | |
| Pure Water | 30 mL |
| Silane Coupling Agent c: 3-aminopropyltriethoxysilane | 1 mL |
| ((C₂H₅O)₃SiC₃H₆NH₂), manufactured by | |
| Shin-Etsu Chemical Co., Ltd., KBE-903) (see below) | |

### (Formation of Second Underlayer)

The prepared application liquid for forming a second underlayer (KBE-903 concentration: 1.0 vol %) was applied onto the first underlayer of the base material by a spin coating method under the condition that the layer thickness of the second underlayer after drying became 20 nm. The conditions of the spin coating were 3,000 rpm and 20 seconds. Thereafter, the base material was dried at room temperature for 1 hour, and then subjected to heat treatment under the conditions of 90° C. and 80% RH for 1 hour.

### (5) Formation of Liquid Repellent Layer

### (Preparation of Application Liquid for Forming Liquid Repellent Layer)

The following constituent materials were mixed to prepare an application liquid for forming a liquid repellent layer.

| | |
|---|---|
| Mixed Solution of Ethanol and 2,2,2-trifluoroethanol (8:2 in | 69.8 mL |
| volume ratio) | |
| Pure Water | 30 mL |
| Fluorine Containing-Coupling Agent b: | 0.2 mL |
| (2-perfluorooctyl)ethyltrimethoxysilane | |
| (CF₃(CF₂)₇C₂H₄Si(OCH₃)₃) | |

### (Formation of Liquid Repellent Layer)

The prepared application liquid for forming a liquid repellent layer containing 0.2 vol % of the fluorine-containing coupling agent b (see below) was applied onto the formed second underlayer by a spin coating method under the condition that the layer thickness of the liquid repellent layer after drying became 10 nm. The conditions of the spin coating were 1,000 rpm and 20 seconds. Thereafter, the base material was dried at room temperature for 1 hour, and then subjected to heat treatment under the conditions of 90° C. and 80% RH for 1 hour, thereby producing a nozzle plate 1.

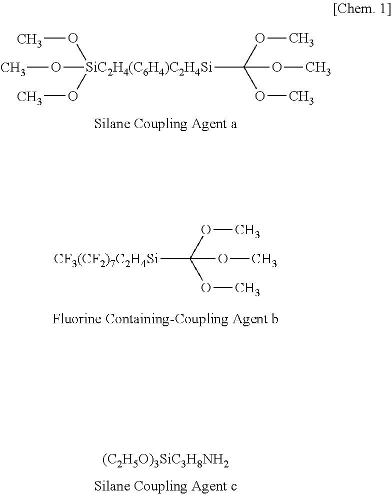

### [Production of Nozzle Plate 2]

A nozzle plate 2 was produced in the same manner as the nozzle plate 1 except that after the base material adhesion layer was formed, a treatment in the O₂-RIE plasma mode was performed using a high-frequency plasma apparatus by the following method.

The plasma treatment conditions were as follows.
Plasma Treatment Apparatus: High-frequency Plasma Apparatus in RIE Mode
Reactant Gas G: Oxygen Gas
Gas Flow Rate: 30 sccm
Gas Pressure: 10 Pa
High-frequency Power: 13.56 MHz
High-frequency Power Density: 0.10 W/cm²
Inter-electrode Voltage: 450 W
Treatment Time: 5 min

### [Production of Nozzle Plate 3]

A nozzle plate 3 was produced in the same manner as the nozzle plate 1 except that after the base material adhesion layer was formed, a treatment in the Ar-RIE plasma mode was performed using a high-frequency plasma apparatus by the following method.

The plasma treatment conditions were as follows.
Plasma Treatment Apparatus: High-frequency Plasma Apparatus in RIE Mode
Reactant Gas G: Argon Gas
Gas Flow Rate: 50 sccm
Gas Pressure: 10 Pa
High-frequency Power: 13.56 MHz
High-frequency Power Density: 0.10 W/cm²
Inter-electrode Voltage: 450 W
Treatment Time: 5 min

### [Production of Nozzle Plate 4]

A nozzle plate 4 was produced in the same manner as the nozzle plate 1 except that at the time of formation of the base material adhesion layer, the film formation was performed using a Ti target by the following method.
Target: Ti
DC Power Density: 1.1 W/cm²
Power: 200 W
Temperature: 25° C.
Pressure: 0.3 Pa
Introduced Gas: Argon Gas+Nitrogen Gas
Film Formation Time: 6 min

### [Production of Nozzle Plate 5]

A nozzle plate 5 was produced in the same manner as the nozzle plate 1 except that at the time of formation of the base material adhesion layer, the film formation was performed using a Ta target by the following method.
Target: Ta
DC Power Density: 1.1 W/cm²
Power: 200 W
Temperature: 25° C.
Pressure: 0.3 Pa
Introduced Gas: Argon Gas
Film Formation Time: 2 min 30 sec

### [Production of Nozzle Plate 6]

A nozzle plate 5 was produced in the same manner as the nozzle plate 1 except that at the time of formation of the base material adhesion layer, the film formation was performed using a Ti target by the following method.
Target: Ti
DC Power Density: 1.1 W/cm²
Power: 200 W
Temperature: 25° C.
Pressure: 0.3 Pa
Introduced Gas: Argon Gas
Film Formation Time: 1 min 30 sec

Regarding each of the produced nozzle plates, composition analysis in the thickness direction of the base material adhesion layer was performed by the above-described XPS analysis, and the elemental composition on the surface of and inside the base material adhesion layer are shown in a table below. Specific conditions were as follows.
Analyzer: QUANTERA SXM manufactured by ULVAC-PHI, Inc.
X-ray Source: Monochromatized Al-Kα 15 kV 25 W
Sputter Ion: Ar (1 keV)
Depth Profile: Measurement is repeated at predetermined thickness intervals with the sputter thickness in terms of SiO2 to obtain the depth profile in the depth direction. This thickness-to-thickness interval is 2.6 nm (data at every 2.6 nm in the depth direction is obtained).
Quantification: The background is obtained by the Shirley method, and quantification is performed from the obtained peak area using the relative sensitivity coefficient method. For data processing, MultiPak manufactured by ULVAC-PHI, Inc. is used.

### [Evaluation]

### (1) Evaluation of Ink Durability

### (Formation of Nozzle Holes)

In each of the produced nozzle plates 1 to 6, a plurality of nozzle holes configured as shown in FIG. 1 or FIG. 2 and having a diameter of 25 μm was formed by using a laser processing machine.

### (Preparation of Actual Ink for Evaluation: Disperse Dye Ink)

### <Preparation of Dispersion>

Disperse Dye: C. I. Disperse Yellow 160 240 mass %
Diethylene Glycol 30.6 mass %
Styrene-Maleic Anhydride Copolymer (Dispersant) 120 mass %
Water 33.4 mass %

The mixture was dispersed with ceramic beads having a diameter of 0.5 mm using a sand grinder manufactured by Imex Co., Ltd. at a revolution of 2,500 rpm for 5 hours. This dispersion was diluted with water/diethylene glycol=1:4 such that a dye concentration became 5%, thereby preparing a dispersion 1.

### <Preparation of Actual Ink>

The dispersion 1 was added with each composite and stirred, thereby preparing actual ink for evaluation (disperse dye ink).

| | |
|---|---|
| Dispersion 1 | 20.0 mass % |
| Ethylene Glycol | 10.0 mass % |
| Glycerin | 8.0 mass % |
| EMULGEN 911 (manufactured by Kao Corporation) | 0.05 mass % |

Ion-exchanged water was added to be 100 mass %. In addition, liquidity of the prepared ink was examined and alkalinity (pH 8.0 or more) was confirmed.

### (Evaluation of Nozzle Plate)

Each nozzle plate in which the nozzle holes were formed was immersed in the actual ink of 65° C. for 40 days.

After the immersion treatment, washing with pure water and drying were performed, and then presence/absence of peeling between the base material and the base material adhesion layer inside the nozzle holes as shown in FIG. 1 or FIG. 2 was observed with a 100-power magnifying glass, and adhesion durability of the nozzle holes with respect to the actual ink was evaluated in accordance with the following criteria.
AAA: No occurrence of peeling is observed in all nozzles.
AA: Extremely weak peeling is observed in nozzles of less than 5%, but there is no problem in practical use.
A: Weak isolation is observed in nozzles of 5% or more and less than 10%, but quality is acceptable in practical use.
B: There is a nozzle(s) where clear peeling is observed, and quality may cause a problem in practical use.

### (2) Rubbing Resistance (Wiping Resistance)

### (Preparation of Black Ink)

Black ink for evaluation configured as follows was prepared.

### <Preparation of Black Pigment Dispersion>

| | |
|---|---|
| C. I. Pigment Black 6 | 12 g |
| PB822 (manufactured by Ajinomoto Fine-Techno Co., Ltd.) | 5 g |
| Methyl Isopropyl Sulfone | 5 g |
| Triethylene Glycol Monobutyl Ether | 68 g |
| Ethylene Glycol Diacetate | 10 g |

These were mixed and dispersed with a horizontal bead mill filled with zirconia beads of 0.3 mm at a volume fraction of 60%, thereby obtaining a black pigment dispersion. The mean particle diameter was 125 nm.

### <Preparation of Black Ink>

| | |
|---|---|
| Black Pigment Dispersion | 33 g |
| Ethylene Glycol Monobutyl Ether | 57 g |
| Triethylene Glycol Monomethyl Ether Acetate | 6.7 g |
| N-methyl-2-pyrrolidone | 3.3 g |

### (Wiping Test)

In a container containing the prepared black ink of 25° C., each of the nozzle plates in each of which the nozzle holes were formed by the above-described method was fixed by a fixing metal with the liquid repellent layer facing upward, and a wiping (sweeping) operation was performed multiple times on the surface of the liquid repellent layer of the nozzle plate using a wiper blade made of ethylenepropylene-diene rubber, and rubbing durability was evaluated in accordance with the following criteria.
AAA: No occurrence of peeling of the liquid repellent layer in the vicinity of a nozzle is observed in all nozzles even by 5,000 times or more of the wiping operation.
AA: No occurrence of peeling of the liquid repellent layer in the vicinity of a nozzle is observed in all nozzles by less than 5,000 times of the wiping operation, but extremely weak peeling is observed in less than 5% of nozzles by 5,000 times or more of the wiping operation.
A: No occurrence of peeling of the liquid repellent layer in the vicinity of a nozzle is observed in all nozzles by less than 1,000 times of the wiping operation, but extremely weak peeling is observed in less than 5% of nozzles by 1,000 to 5,000 times of the wiping operation.
B: There is a nozzle(s) where clear peeling of the liquid repellent layer which may cause a problem in practical use is observed by 1,000 times of the wiping.

### (3) Evaluation of Continuous Ejection Property

Ink made of a black pigment dispersion and triethylene glycol monomethyl ether acetate was introduced into an inkjet head with each of the nozzles prepared in the nozzle plates 1 to 4 as examples and the nozzle plates 5 and 6 as comparative examples joined, continuous ejection was performed from all the nozzles with a gap of about 6 mm with respect to media, and ejection after continuous ejection for 30 minutes (continuous ejection property) was evaluated in accordance with the following criteria.
A: No significant droplet adhesion is observed on the nozzle surface even after continuous ejection for 30 minutes, and normal ejection is maintained.
B: Clear droplet adhesion is observed on the nozzle surface after continuous ejection for 30 minutes, and ejection failure is partly confirmed.

TABLE I

| NOZZLE PLATE NO. | | | 1 | | 2 | | 3 | |
|---|---|---|---|---|---|---|---|---|
| BASE MATERIAL | | | STAINLESS | | STAINLESS | | STAINLESS | |
| | | | STEEL | | STEEL | | STEEL | |
| | | | WITHOUT | | WITHOUT | | WITHOUT | |
| | | | NOZZLE | | NOZZLE | | NOZZLE | |
| | | | HOLE | | HOLE | | HOLE | |
| BASE | COMPOSITION | | TANTALUM | | TANTALUM | | TANTALUM | |
| MATERIAL | | | NITRIDE | | NITRIDE | | NITRIDE | |
| ADHESION | SPUTTERING | TARGET | Ta | | Ta | | Ta | |
| LAYER | FILM | GAS | Ar + N₂ | | Ar + N₂ | | Ar + N₂ | |
| | FORMATION | | | | | | | |
| | CONDITIONS | | | | | | | |
| | FILM THICKNESS [nm] | | 20 | | 20 | | 20 | |
| SURFACE TREATMENT ON BASE | | | NO | | O₂ | | Ar | |
| MATERIAL ADHESION LAYER | | | TREATMENT | | PLASM | | PLASM | |
| ELEMENTAL | | | SURFACE | INSIDE | SURFACE | INSIDE | SURFACE | INSIDE |
| COMPOSITION | | C | 15.48 | — | 15.43 | — | 14.29 | — |
| (Atomic %) ON SURFACE | | N | 19.97 | 26.78 | 1.30 | 28.25 | 1.29 | 28.58 |
| OF AND INSIDE BASE | | O | 30.78 | 11.89 | 57.15 | 9.36 | 57.18 | 9.02 |
| MATERIAL ADHESION | | Si | — | — | — | — | — | — |
| LAYER (—: DETECTION | | Ti | — | — | — | — | — | — |
| LOWER LIMIT OR LESS | | Ta | 33.77 | 61.33 | 26.12 | 62.39 | 27.24 | 62.40 |
| (<0.1 Atomic %)) | | TOTAL | 100.0 | 100.0 | 100.0 | 100.0 | 100.0 | 100.0 |
| ATOMIC | | SURFACE/ | 2.59 | | 6.10 | | 6.34 | |
| CONCENTRATION | | INSIDE | | | | | | |
| RATIO OF OXYGEN | | | | | | | | |
| ELEMENT | | | | | | | | |
| ATOMIC | | | SURFACE | INSIDE | SURFACE | INSIDE | SURFACE | INSIDE |
| CONCENTRATION | | N/Ta | 0.59 | 0.44 | 0.05 | 0.45 | 0.05 | 0.46 |
| RATIO OF BASE | | OR N/Ti | | | | | | |
| MATERIAL ADHESION | | O/Ta | 0.91 | 0.19 | 2.19 | 0.15 | 2.10 | 0.14 |
| LAYER | | OR O/Ti | | | | | | |
| UNDERLAYER | | | TWO LAYERS | | TWO LAYERS | | TWO LAYERS | |
| LIQUID REPELLENT LAYER | | | PRESENT | | PRESENT | | PRESENT | |
| *1 | INK DURABILITY | | AA | | AAA | | AA | |
| | RUBBING RESISTANCE | | AA | | AA | | AA | |
| | CONTINUOUS | | A | | A | | A | |
| | EJECTION PROPERTY | | | | | | | |
| REMARKS | | | PRESENT | | PRESENT | | PRESENT | |
| | | | INVENTION | | INVENTION | | INVENTION | |
| NOZZLE PLATE NO. | | | 4 | | 5 | | 6 | |
| BASE MATERIAL | | | STAINLESS | | STAINLESS | | STAINLESS | |
| | | | STEEL | | STEEL | | STEEL | |
| | | | WITHOUT | | WITHOUT | | WITHOUT | |
| | | | NOZZLE | | NOZZLE | | NOZZLE | |
| | | | HOLE | | HOLE | | HOLE | |
| BASE | COMPOSITION | | TITANIUM | | TANTALUM | | TITANIUM | |
| MATERIAL | | | NITRIDE | | OXID | | OXIDE | |
| ADHESION | SPUTTERING | TARGET | Ti | | Ta | | Ti | |
| LAYER | FILM | GAS | Ar + N₂ | | Ar | | Ar | |
| | FORMATION | | | | | | | |
| | CONDITIONS | | | | | | | |

| | | | |
|---|---|---|---|
| FILM THICKNESS [nm] | 20 | 20 | 20 |

| SURFACE TREATMENT ON BASE | | NO | | NO | | NO | |
|---|---|---|---|---|---|---|---|
| MATERIAL ADHESION LAYER | | TREATMENT | | TREATMENT | | TREATMENT | |
| ELEMENTAL | | SURFACE | INSIDE | SURFACE | INSIDE | SURFACE | INSIDE |
| COMPOSITION | C | 32.40 | 2.00 | 18.40 | — | 24.60 | — |
| (Atomic %) ON SURFACE | N | 17.50 | 28.60 | — | — | — | — |
| OF AND INSIDE BASE | O | 31.10 | 30.10 | 51.30 | 16.50 | 53.61 | 50.1 |
| MATERIAL ADHESION | Si | — | — | — | — | — | — |
| LAYER (—: DETECTION | Ti | 19.00 | 39.30 | — | — | 21.79 | 49.90 |
| LOWER LIMIT OR LESS | Ta | — | — | 30.30 | 83.50 | — | — |
| (<0.1 Atomic %)) | TOTAL | 100.0 | 100.0 | 100.0 | 100.0 | 100.0 | 100.0 |
| ATOMIC | SURFACE/ | 1.03 | | 3.11 | | 1.07 | |
| CONCENTRATION | INSIDE | | | | | | |
| RATIO OF OXYGEN | | | | | | | |
| ELEMENT | | | | | | | |
| ATOMIC | | SURFACE | INSIDE | SURFACE | INSIDE | SURFACE | INSIDE |
| CONCENTRATION | N/Ta | 0.92 | 0.73 | — | — | — | — |
| RATIO OF BASE | OR N/Ti | | | | | | |
| MATERIAL ADHESION | O/Ta | 1.64 | 0.77 | 1.69 | 0.20 | 2.46 | 1.00 |
| LAYER | OR O/Ti | | | | | | |

| UNDERLAYER | | TWO LAYERS | TWO LAYERS | TWO LAYERS |
|---|---|---|---|---|
| LIQUID REPELLENT LAYER | | PRESENT | PRESENT | PRESENT |
| *1 | INK DURABILITY | AA | A | B |
| | RUBBING RESISTANCE | AA | AA | B |
| | CONTINUOUS | A | B | B |
| | EJECTION PROPERTY | | | |

| REMARKS | PRESENT | COMPARATIVE | COMPARATIVE |
|---|---|---|---|
| | INVENTION | EXAMPLE | EXAMPLE |

*1: EVALUATIONS

As shown in the above results, it has been found that the nozzle plates having the configuration defined in the present invention have higher bondability between the base material adhesion layer and the underlayer and is more excellent in ink resistance than those as the comparative examples even in the environment where nozzle plates are exposed to an ink component for a long time because the base material adhesion layer contains nitrogen and the oxygen concentration on the surface is higher than that of the inside.

Further, according to the evaluation of the continuous ejection property, the adhesion of liquid droplets to the nozzle surface having the base material adhesion layer containing nitrogen was a little. This phenomenon is considered to be a result of the nozzle surface not being charged and suppression of mist adhesion due to ejection because the surface resistance of the nitrogen-containing base material adhesion layer was low (when it was confirmed by attaching, to Hiresta-UX manufactured by Nitto Seiko Analytech Co., Ltd., a UA probe (2-pin type), the resistance value was a measurement limit or less).

### Example 2

Nozzle plates 7 to 10 were produced as in the production of the nozzle plates 1 to 4 of Example 1, but the liquid repellent layer (fluorine containing-coupling agent) was directly formed on the base material adhesion layer without the first underlayer and the second underlayer provided. At the time, as the fluorine-containing coupling agent, OPTOOL DSX (manufactured by Daikin Industries, Ltd) was used instead of the fluorine-containing coupling agent b.

In addition, nozzle plates 11 to 14 were produced as in the production of the nozzle plates 1 to 4 of Example 1, but after the nozzle holes were formed in the stainless-steel base material (SUS304) by laser processing, the base material adhesion layer was formed by sputtering, and the liquid repellent layer (fluorine-containing coupling agent) was formed directly. At the time, as the fluorine-containing coupling agent, OPTOOL DSX (manufactured by Daikin Industries, Ltd) was used instead of the fluorine-containing coupling agent b.

In addition, nozzle plates 15 and 16 were produced in the same manner as the plate 12 except that the thickness of the base material adhesion layer was changed as shown in Table III below by changing the film formation time. The film formation conditions for the nozzle plates 15 and 16 are as follows.

### (Nozzle Plate 15)

Target: Ta
DC Power Density: 1.1 W/cm²
Power: 200 W
Temperature: 25° C.
Pressure: 0.3 Pa
Introduced Gas: Argon Gas+Nitrogen Gas
Film Formation Time: 100 min
Layer Thickness: 200 nm

### (Nozzle Plate 16)

Target: Ta
DC Power Density: 1.1 W/cm²
Power: 200 W
Temperature: 25° C.
Pressure: 0.3 Pa
Introduced Gas: Argon Gas+Nitrogen Gas
Film Formation Time: 500 min
Layer Thickness: 1,000 nm

These nozzle plates 11 to 16 were evaluated for ink resistance, rubbing durability, and continuous ejection evaluation in the same methods as those described in Example 1. The results are shown in Tables II and III below. Similarly to the results of Example 1, excellent effects on ink durability, rubbing durability, and continuous ejection stability were able to be confirmed.

### Example 3

A base material adhesion layer was formed on a plate in which nozzle holes were formed in a silicon wafer by a Deep-RIE method in the same manner as the nozzle plate 1 of Example 1, and a hydrogen repellent (fluorine-containing coupling agent) was directly formed thereon, thereby producing a nozzle plate 17. At the time, as the fluorine-containing coupling agent, OPTOOL DSX (manufactured by Daikin Industries, Ltd) was used instead of the fluorine-containing coupling agent b.

This nozzle plate 17 was evaluated for ink durability, rubbing durability, and continuous ejection evaluation in the same methods as those described in Example 1. The results are shown in Table III below.

Similarly to the results of Example 1, excellent effects on ink resistance, rubbing durability, and continuous ejection stability were able to be confirmed.

TABLE II

| NOZZLE PLATE NO. | | | 7 | | 8 | | 9 | |
|---|---|---|---|---|---|---|---|---|
| BASE MATERIAL | | | STAINLESS | | STAINLESS | | STAINLESS | |
| | | | STEEL | | STEEL | | STEEL | |
| | | | WITHOUT | | WITHOUT | | WITHOUT | |
| | | | NOZZLE | | NOZZLE | | NOZZLE | |
| | | | HOLE | | HOLE | | HOLE | |
| BASE | COMPOSITION | | TANTALUM | | TANTALUM | | TANTALUM | |
| MATERIAL | | | NITRIDE | | NITRIDE | | NITRIDE | |
| ADHESION | SPUTTERING | TARGET | Ta | | Ta | | Ta | |
| LAYER | FILM | GAS | Ar + N₂ | | Ar + N₂ | | Ar + N₂ | |
| | FORMATION | | | | | | | |
| | CONDITIONS | | | | | | | |
| | FILM THICKNESS [nm] | | 20 | | 20 | | 20 | |
| SURFACE TREATMENT ON BASE | | | NO | | O₂ | | Ar | |
| MATERIAL ADHESION LAYER | | | TREATMENT | | PLASM | | PLASM | |
| ELEMENTAL | | | SURFACE | INSIDE | SURFACE | INSIDE | SURFACE | INSIDE |
| COMPOSITION | | C | 15.48 | — | 15.43 | — | 14.29 | — |
| (Atomic %) ON SURFACE | | N | 19.97 | 26.78 | 1.30 | 28.25 | 1.29 | 28.58 |
| OF AND INSIDE BASE | | O | 30.78 | 11.89 | 57.15 | 9.36 | 57.18 | 9.02 |
| MATERIAL ADHESION | | Si | — | — | — | — | — | — |
| LAYER (—: DETECTION | | Ti | — | — | — | — | — | — |
| LOWER LIMIT OR LESS | | Ta | 33.77 | 61.33 | 26.12 | 62.39 | 27.24 | 62.40 |
| (<0.1 Atomic %)) | | TOTAL | 100.0 | 100.0 | 100.0 | 100.0 | 100.0 | 100.0 |
| ATOMIC | | SURFACE/ | 2.59 | | 6.10 | | 6.34 | |
| CONCENTRATION | | INSIDE | | | | | | |
| RATIO OF OXYGEN | | | | | | | | |
| ELEMENT | | | | | | | | |
| ATOMIC | | | SURFACE | INSIDE | SURFACE | INSIDE | SURFACE | INSIDE |
| CONCENTRATION | | N/Ta | 0.59 | 0.44 | 0.05 | 0.45 | 0.05 | 0.46 |
| RATIO OF BASE | | OR N/Ti | | | | | | |
| MATERIAL ADHESION | | O/Ta | 0.91 | 0.19 | 2.19 | 0.15 | 2.10 | 0.14 |
| LAYER | | OR O/Ti | | | | | | |
| UNDERLAYER | | | ABSENT | | ABSENT | | ABSENT | |
| LIQUID REPELLENT LAYER | | | PRESENT | | PRESENT | | PRESENT | |
| *1 | INK DURABILITY | | AA | | AAA | | AA | |
| | RUBBING RESISTANCE | | AA | | AA | | AA | |
| | CONTINUOUS | | A | | A | | A | |
| | EJECTION PROPERTY | | | | | | | |
| REMARKS | | | PRESENT | | PRESENT | | PRESENT | |
| | | | INVENTION | | INVENTION | | INVENTION | |
| NOZZLE PLATE NO. | | | 10 | | 11 | | 12 | |
| BASE MATERIAL | | | STAINLESS | | STAINLESS | | STAINLESS | |
| | | | STEEL | | STEEL | | STEEL | |
| | | | WITHOUT | | WITH | | WITH | |
| | | | NOZZLE | | NOZZLE | | NOZZLE | |
| | | | HOLE | | HOLE | | HOLE | |
| BASE | COMPOSITION | | TITANIUM | | TANTALUM | | TANTALUM | |
| MATERIAL | | | NITRIDE | | NITRIDE | | NITRIDE | |
| ADHESION | SPUTTERING | TARGET | Ti | | Ta | | Ta | |
| LAYER | FILM | GAS | Ar + N₂ | | Ar + N₂ | | Ar + N₂ | |
| | FORMATION | | | | | | | |
| | CONDITIONS | | | | | | | |

| | | | |
|---|---|---|---|
| FILM THICKNESS [nm] | 20 | 20 | 20 |

| SURFACE TREATMENT ON BASE | | NO | | NO | | O₂ | |
|---|---|---|---|---|---|---|---|
| MATERIAL ADHESION LAYER | | TREATMENT | | TREATMENT | | PLASM | |
| ELEMENTAL | | SURFACE | INSIDE | SURFACE | INSIDE | SURFACE | INSIDE |
| COMPOSITION | C | 32.4 | 2.00 | 15.48 | — | 15.43 | — |
| (Atomic %) ON SURFACE | N | 17.50 | 28.60 | 19.97 | 26.78 | 1.30 | 28.25 |
| OF AND INSIDE BASE | O | 31.10 | 30.10 | 30.78 | 11.89 | 57.15 | 9.36 |
| MATERIAL ADHESION | Si | — | — | — | — | — | — |
| LAYER (—: DETECTION | Ti | 19.00 | 39.30 | — | — | — | — |
| LOWER LIMIT OR LESS | Ta | — | — | 33.77 | 61.33 | 26.12 | 62.39 |
| (<0.1 Atomic %)) | TOTAL | 100.0 | 100.0 | 100.0 | 100.0 | 100.0 | 100.0 |
| ATOMIC | SURFACE/ | 1.03 | | 2.59 | | 6.10 | |
| CONCENTRATION | INSIDE | | | | | | |
| RATIO OF OXYGEN | | | | | | | |
| ELEMENT | | | | | | | |
| ATOMIC | | SURFACE | INSIDE | SURFACE | INSIDE | SURFACE | INSIDE |
| CONCENTRATION | N/Ta | 0.92 | 0.73 | 0.59 | 0.44 | 0.05 | 0.45 |
| RATIO OF BASE | OR N/Ti | | | | | | |
| MATERIAL ADHESION | O/Ta | 1.64 | 0.77 | 0.91 | 0.19 | 2.19 | 0.15 |
| LAYER | OR O/Ti | | | | | | |

| UNDERLAYER | | ABSENT | ABSENT | ABSENT |
|---|---|---|---|---|
| LIQUID REPELLENT LAYER | | PRESENT | PRESENT | PRESENT |
| *1 | INK DURABILITY | AA | AA | AAA |
| | RUBBING RESISTANCE | AA | AA | AA |
| | CONTINUOUS | A | A | A |
| | EJECTION PROPERTY | | | |

| REMARKS | PRESENT | PRESENT | PRESENT |
|---|---|---|---|
| | INVENTION | INVENTION | INVENTION |

*1: EVALUATIONS

TABLE III

| NOZZLE PLATE NO. | | | 13 | 14 | 15 |
|---|---|---|---|---|---|
| BASE MATERIAL | | | STAINLESS | STAINLESS | STAINLESS |
| | | | STEEL | STEEL | STEEL |
| | | | WITH | WITH | WITH |
| | | | NOZZLE | NOZZLE | NOZZLE |
| | | | HOLE | HOLE | HOLE |
| BASE | COMPOSITION | | TANTALUM | TITANIUM | TANTALUM |
| MATERIAL | | | NITRIDE | NITRIDE | NITRIDE |
| ADHESION | SPUTTERING | TARGET | Ta | Ti | Ta |
| LAYER | FILM | GAS | Ar + N₂ | Ar + N₂ | Ar + N₂ |
| | FORMATION | | | | |
| | CONDITIONS | | | | |

| | | | |
|---|---|---|---|
| FILM THICKNESS [nm] | 20 | 20 | 200 |

| SURFACE TREATMENT ON BASE | | Ar | | NO | | O₂ | |
|---|---|---|---|---|---|---|---|
| MATERIAL ADHESION LAYER | | PLASM | | TREATMENT | | PLASM | |
| ELEMENTAL | | SURFACE | INSIDE | SURFACE | INSIDE | SURFACE | INSIDE |
| COMPOSITION | C | 14.29 | — | 32.40 | 2.00 | 15.43 | — |
| (Atomic %) ON SURFACE | N | 1.29 | 28.58 | 17.50 | 28.06 | 1.30 | 28.25 |
| OF AND INSIDE BASE | O | 57.18 | 9.02 | 31.10 | 30.10 | 57.15 | 9.36 |
| MATERIAL ADHESION | Si | — | — | — | — | — | — |
| LAYER (—: DETECTION | Ti | — | — | 19.00 | 39.30 | — | — |
| LOWER LIMIT OR LESS | Ta | 27.24 | 62.40 | — | — | 26.12 | 62.39 |
| (<0.1 Atomic %)) | TOTAL | 100.0 | 100.0 | 100.0 | 100.0 | 100.0 | 100.0 |
| ATOMIC | SURFACE/ | 6.34 | | 1.03 | | 6.10 | |
| CONCENTRATION | INSIDE | | | | | | |
| RATIO OF OXYGEN | | | | | | | |
| ELEMENT | | | | | | | |
| ATOMIC | | SURFACE | INSIDE | SURFACE | INSIDE | SURFACE | INSIDE |
| CONCENTRATION | N/Ta | 0.05 | 0.46 | 0.92 | 0.73 | 0.05 | 0.45 |
| RATIO OF BASE | OR N/Ti | | | | | | |
| MATERIAL ADHESION | O/Ta | 2.10 | 0.14 | 1.64 | 0.77 | 2.19 | 0.15 |
| LAYER | OR O/Ti | | | | | | |

| UNDERLAYER | | ABSENT | ABSENT | ABSENT |
|---|---|---|---|---|
| LIQUID REPELLENT LAYER | | PRESENT | PRESENT | PRESENT |
| EVALUATIONS | INK DURABILITY | AA | AA | AAA |
| | RUBBING RESISTANCE | AA | AA | AAA |
| | CONTINUOUS | A | A | A |
| | EJECTION PROPERTY | | | |

| REMARKS | PRESENT | PRESENT | PRESENT |
|---|---|---|---|
| | INVENTION | INVENTION | INVENTION |

| NOZZLE PLATE NO. | | | 16 | 17 |
|---|---|---|---|---|
| BASE MATERIAL | | | STAINLESS | STAINLESS |
| | | | STEEL | STEEL |
| | | | WITH | WITH |
| | | | NOZZLE | NOZZLE |
| | | | HOLE | HOLE |
| BASE | COMPOSITION | | TANTALUM | TANTALUM |
| MATERIAL | | | NITRIDE | NITRIDE |
| ADHESION | SPUTTERING | TARGET | Ta | Ta |
| LAYER | FILM | GAS | Ar + N₂ | Ar + N₂ |

FORMATION
CONDITIONS

| | | |
|---|---|---|
| FILM THICKNESS [nm] | 1000 | 20 |

| SURFACE TREATMENT ON BASE | | O₂ | | NO | |
|---|---|---|---|---|---|
| MATERIAL ADHESION LAYER | | PLASM | | TREATMENT | |
| ELEMENTAL | | SURFACE | INSIDE | SURFACE | INSIDE |
| COMPOSITION | C | 15.43 | — | 15.48 | — |
| (Atomic %) ON SURFACE | N | 1.30 | 28.25 | 19.97 | 26.78 |
| OF AND INSIDE BASE | O | 57.15 | 9.36 | 30.78 | 11.89 |
| MATERIAL ADHESION | Si | — | — | — | — |
| LAYER (—: DETECTION | Ti | — | — | — | — |
| LOWER LIMIT OR LESS | Ta | 26.12 | 62.39 | 33.77 | 61.33 |
| (<0.1 Atomic %)) | TOTAL | 100.0 | 100.0 | 100.0 | 100.0 |
| ATOMIC | SURFACE/ | 6.10 | | 2.59 | |
| CONCENTRATION | INSIDE | | | | |
| RATIO OF OXYGEN | | | | | |
| ELEMENT | | | | | |
| ATOMIC | | SURFACE | INSIDE | SURFACE | INSIDE |
| CONCENTRATION | N/Ta | 0.05 | 0.45 | 0.59 | 0.44 |
| RATIO OF BASE | OR N/Ti | | | | |
| MATERIAL ADHESION | O/Ta | 2.19 | 0.15 | 0.91 | 0.19 |
| LAYER | OR O/Ti | | | | |

| UNDERLAYER | | ABSENT | ABSENT |
|---|---|---|---|
| LIQUID REPELLENT LAYER | | PRESENT | PRESENT |
| EVALUATIONS | INK DURABILITY | AAA | AA |
| | RUBBING RESISTANCE | AAA | AA |
| | CONTINUOUS | A | A |

EJECTION PROPERTY

| | | |
|---|---|---|
| REMARKS | PRESENT | PRESENT |

| | |
|---|---|
| INVENTION | INVENTION |

Further, the nozzle plates 1 to 17 were measured under the following conditions using an X-ray diffraction apparatus (multipurpose X-ray diffractometer Ultima III manufactured by Rigaku Corporation), so that X-ray diffraction patterns of the base material adhesion layers were obtained.
Apparatus: Multipurpose X-ray Diffractometer Ultima III manufactured by Rigaku Corporation
X-ray Source: Cu-kα 40 kV-30 mA
Scanning Axis: θ/2θ
Scanning Range: 25′ to 85′ (Sampling Width: 0.02°)
Scan Speed: 10°/min

In the obtained X-ray diffraction spectrum, a peak with 2θ being 32.6° was confirmed regarding each of the nozzle plates 1 to 4 and 7 to 17.

### INDUSTRIAL APPLICABILITY

The present invention can be used for a member for an inkjet head, a method for manufacturing a member for an inkjet head, and an inkjet head which can secure long-term durability and rubbing durability with respect to ink and are excellent in continuous ejection property.

### REFERENCE SIGNS LIST

1 Nozzle Plate
2 Base Material
3 Base Material Adhesion Layer
4 Functional Layer
41 Underlayer
41a First Underlayer
41b Second Underlayer
42 Liquid Repellent Layer
20A RIE Plasma Treatment Apparatus
21 Reaction Chamber
22 High-frequency Power Source
23 Capacitor
24 Planar Electrode (Power Feed Electrode)
25 Counter Electrode (Ground Electrode)
26 Earth
27 Gas Inlet
28 Gas Outlet
30 Nozzle Plate Base Material
31 Discharge Space
32, 33 Feed Line
56 Housing
57 Cap Receiving Plate
59 Cover Member
61 Nozzle Plate
62 Cap Receiving Plate Attachment Portion
68 Attachment Hole
71 Opening Portion for Nozzle
81a First Joint
81b Second Joint
82 Third Joint
100 Inkjet Head
D Discharge
G Reaction Gas
N Nozzle
P Pump
In Ink

1. A member for an inkjet head comprising at least a base material, a base material adhesion layer and a functional layer in this order,
wherein the base material adhesion layer contains a Group 4 or Group 5 element, a nitrogen element and an oxygen element, and
wherein an atomic concentration (atm %) of the oxygen element on a surface of the base material adhesion layer on a functional layer side where the functional layer is provided is higher than an atomic concentration (atm %) thereof inside the base material adhesion layer.

2. The member for an inkjet head according to claim 1, wherein the Group 5 element contained in the base material adhesion layer is tantalum (Ta).

3. The member for an inkjet head according to claim 1, wherein a value of a ratio of an atomic concentration (atm %) of the nitrogen element and an atomic concentration (atm %) of the Group 4 or Group 5 element inside the base material adhesion layer satisfies Formula (I) below:
0.3≤Atomic Concentration of Nitrogen Element/Atomic Concentration of Group 4 or Group 5 Element≤1. Formula (I):

4. The member for an inkjet head according to claim 1, wherein the base material adhesion layer has a peak derived from Ta₂N in X-ray diffraction (XRD) measurement.

5. The member for an inkjet head according to claim 1, wherein the base material adhesion layer has a thickness within a range of 1 to 1,500 nm.

6. The member for an inkjet head according to claim 1, wherein the functional layer includes a liquid repellent layer containing a fluorine (F) containing-coupling agent.

7. The member for an inkjet head according to claim 1, wherein the functional layer includes a liquid repellent layer containing a fluorine (F) containing-coupling agent, and an underlayer serving as a base of the liquid repellent layer.

8. The member for an inkjet head according to claim 7, wherein the underlayer is a layer containing at least an inorganic oxide or an oxide containing carbon (C).

9. The member for an inkjet head according to claim 8, wherein the underlayer contains an oxide made of at least carbon (C), silicon (Si) and oxygen (O).

10. The member for an inkjet head according to claim 8, wherein the underlayer is a layer made of a silane coupling agent containing at least carbon (C) and oxygen (O).

11. The member for an inkjet head according to claim 10, wherein the silane coupling agent contained in the underlayer has a molecular structure having reactive functional groups at both ends and including a hydrocarbon chain and a benzene ring at a middle portion.

12. The member for an inkjet head according to claim 1, wherein the base material is formed of stainless steel.

13. A method for manufacturing a member for an inkjet head for manufacturing the member for an inkjet head according to claim 1, comprising:
forming the base material adhesion layer on the base material; and
after forming the functional layer on the base material adhesion layer, forming a nozzle by laser processing.

14. The method for manufacturing a member for an inkjet head according to claim 13, wherein the base material adhesion layer is formed by a reactive sputtering method with a dry process.

15. The method for manufacturing a member for an inkjet head according to claim 13, wherein an oxygen plasma treatment is performed as a surface treatment on the base material adhesion layer.

16. An inkjet head comprising the member for an inkjet head according to claim 1.
